(19) United States
(12) Patent Application Publication
(10) Pub. No.: US 2007/0282536 A1
(43) Pub. Date: Dec. 6, 2007

(54) Method and apparatus for evaluating interaction between protein complexes, and computer product

(75) Inventors: Hiroshi Yamakawa, Kawasaki (JP); Kouji Maruhashi, Kawasaki (JP); Yoshio Nakao, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/523,883

(22) Filed: Sep. 20, 2006

(30) Foreign Application Priority Data
May 30, 2006 (JP) 2006-150672

(51) Int. Cl. G06F 19/00

(52) U.S. Cl. 702/19

(57) ABSTRACT

In an interaction evaluating apparatus, a sub-unit forming unit uses complex pair information as input information and refers to a family DB to make sub-units of the complex pair information. A GODB is a database that stores information relating to the protein attributes. A learning unit uses sub-unit complex pair information as input information and refers to the GODB to output a prediction rule set. An executing unit uses prediction target data obtained from a prediction-target generating unit as input information and refers to the prediction rule set to calculate an execution result, i.e., an attribute score that is validation evaluation of an interaction attribute of a sub-unit pair.

### CROSS-REFERENCE TO RELATED APPLICATIONS

This application is based upon and claims the benefit of priority from the prior Japanese Patent Application No. 2006-150672, filed on May 30, 2006, the entire contents of which are incorporated herein by reference.

### BACKGROUND OF THE INVENTION

1. Field of the Invention

The present invention relates to a technology for evaluating validity of an interaction attribute of protein complexes.

2. Description of the Related Art

To understand a molecular biological mechanism in an organism, it is useful to comprehend interaction attributes (directions and types such as activation, phosphorylation, inhibition, etc.) of interaction between protein complexes.

On the other hand, in the case of a protein complex interaction predicted by a heuristic technique, it is often the case that only the presence of the interaction is predicted. Although an interaction attribute can be extracted by a natural language process making a pair with the use of documents, the result includes noise. Data relating to the interaction between protein complexes currently include KEGG (Kyoto Encyclopedia of Genes and Genomes, [online], [retrieved on Feb. 27, 2006], Internet <URL: http://www.genome.jp/keg/pathway.html>), etc.

FIG. 33 is a schematic for illustrating interaction between protein complexes. When focusing on a relationship between the protein complexes in information of a protein complex pair (hereinafter, “complex pair information”) 3300, a protein complex CL1 includes proteins P101 to P104, P111 to P113, and a protein complex CR2 includes proteins P201 to P203, P211, P212, P221, P231.

If “L” is added to a reference numeral of a protein complex in the description, this represents a protein complex giving interaction. If “R” is added to a reference numeral of a protein complex, this represents a protein complex receiving interaction. In the case of FIG. 33, the protein complex CL1 is a protein complex giving interaction and the protein complex CR1 is a protein complex receiving the interaction. The interaction attribute (phosphorylation in this case) is specified between two protein complexes CL1 and CR2.

Conventionally, a multiplicity of technologies exists for estimating presence of the interaction between the protein complexes as shown in FIG. 33. Such technologies are disclosed in, for example, Japanese Patent Laid-Open Publication Nos. 2003-208431, 2003-238587, 2004-203880, 2005-063405; Japanese Patent Publication No. 2002-535972; Nat Biotechnol. August 2005 23(8), 951-959, titled “Probabilistic model of the human protein-protein interaction network” by Rhodes D R, Tomlins S A, et. al.; and CSB2005, titled “A Protein Interaction Verification System Based on a Neural Network Algorithm” by Min Su Lee, Seung Soo Park, and Min Kyung Kim.

Japanese Patent Publication No. 2004-509406 discloses a system for evaluating affinity of a protein and a compound depending on attributes based on the structure of the protein.

Japanese Patent Laid-Open Publication No. 2005-135154 discloses a gene ontology term predicting method that obtains a protein assigned with each of three ontology terms (ontology), two sequence similarity values thereof, and conditions increasing the accuracy of the ontology prediction to predict ontology of a remaining fourth protein.

Japanese Patent Laid-Open Publication No. 2004-030093 discloses a gene-expression-data analyzing method that extracts a common rule from ontology information of a gene group.

Proteins P101 to P104, P111 to P113, P201 to P203, P211, P212, P221, and P231 in each of protein complexes CL1 and CR2 are constituted with a hierarchical structure. FIG. 34 is a schematic of the hierarchical structure of a protein complex pair. In FIG. 34, proteins with the same nature (variants) constitute a sub-unit.

For example, in the protein complex CL1, the proteins P101 to P104 constitute a sub-unit SL10 and the proteins Pill to P113 constitute a sub-unit SL11.

Similarly, in the protein complex CR2, the proteins P201 to P203 constitute a sub-unit SR20; the proteins P211, P212 constitute a sub-unit SR21; the protein P221 constitutes a sub-unit SR22; and the protein P231 constitutes a sub-unit SR23.

If “L” is added to a reference numeral of a sub-unit in the description, this represents a sub-unit in a protein complex giving interaction. If “R” is added to a reference numeral of a sub-unit, this represents a sub-unit in a protein complex receiving interaction.

Although the proteins in each of the sub-units SL10, SL11, and SR21 to SR23 are interchangeable, it is believed that proteins belonging to different sub-units play different roles.

It is believed that the interaction is directly related to a “responsible sub-unit pair” that is a portion of combinations of the sub-units SL10, SL11, and SR21 to SR23 included in the protein complexes CL1 and CR2. Therefore, in the bioinformatics field, the protein interaction attribute must be evaluated at the following two levels (1) and (2):

(1) an interaction attribute at a protein complex level that is necessary for understanding behavior of a whole system; and

(2) an interaction attribute at a sub-unit level that is necessary as basic information supporting drug discovery.

However, in the conventional technologies described above, validity evaluation is not performed at the above two levels for the interaction attribute between the protein complexes.

### SUMMARY OF THE INVENTION

It is an object of the present invention to at least solve the above problem in the conventional technologies.

A computer-readable recording medium according to one aspect of the present invention stores therein a computer program for evaluating interaction between protein complexes. The computer program makes a computer execute extracting, from a group of pair information representing a protein complex pair that includes protein complexes having interaction therebetween, a sub-unit composed of proteins having similar nature among proteins forming the protein complexes; determining whether protein attribute information of the protein included in the sub-unit is present in a group of protein attribute information identifying an attribute of protein; creating sub-unit attribute information that identifies an attribute of the subunit for each of the protein attribute information, by aggregating information on presence or absence of protein attribute information determined at the determining; generating learning data including information on presence or absence of the sub-unit attribute information and interaction attribute information identifying the interaction for each piece of the complex pair information so as to cover all sub-unit pairs formed by combination of sub-units in a protein complex giving the interaction and sub-units in a protein complex receiving the interaction; and extracting a prediction rule applied to prediction-target complex-pair information representing a prediction-target protein-complex pair of which a sub-unit pair affected by the interaction is unknown or a prediction-target protein-complex pair of which interaction is unknown, from a set of rules defining the sub-unit attribute information as a condition and the interaction attribute information as a conclusion, the rules being obtained from a set of the learning data.

A computer-readable recording medium according to another aspect of the present invention stores therein a computer program for evaluating interaction between protein complexes. The computer program making a computer execute acquiring complex pair information representing a protein complex pair affected by interaction identifying, based on a family list in which families representing nature of protein are grouped, an exclusive family that is a representative family representing nature of each of the proteins from among the families in the family list; and grouping proteins forming protein complexes in the complex pair information into sub-units each of which including proteins having a common exclusive family.

An apparatus for evaluating interaction between protein complexes according to still another aspect of the present invention includes a sub-unit extracting unit configured to extract, from a group of pair information representing a protein complex pair that includes protein complexes having interaction therebetween, a sub-unit composed of proteins having similar nature among proteins forming the protein complexes; a determining unit configured to determine whether protein attribute information of the protein included in the sub-unit is present in a group of protein attribute information identifying an attribute of protein; a creating unit configured to create sub-unit attribute information that identifies an attribute of the subunit for each of the protein attribute information, by aggregating information on presence or absence of protein attribute information determined by the determining unit; a generating unit configured to generate learning data including information on presence or absence of the sub-unit attribute information and interaction attribute information identifying the interaction for each piece of the complex pair information so as to cover all sub-unit pairs formed by combination of sub-units in a protein complex giving the interaction and sub-units in a protein complex receiving the interaction; and a prediction-rule extracting unit configured to extract a prediction rule applied to prediction-target complex-pair information representing a prediction-target protein-complex pair of which a sub-unit pair affected by the interaction is unknown or a prediction-target protein-complex pair of which interaction is unknown, from a set of rules defining the sub-unit attribute information as a condition and the interaction attribute information as a conclusion, the rules being obtained from a set of the learning data.

An apparatus for evaluating interaction between protein complexes according to still another aspect of the present invention includes an acquiring unit configured to acquire complex pair information representing a protein complex pair affected by interaction; an identifying unit configured to identify, based on a family list in which families representing nature of protein are grouped, an exclusive family that is a representative family representing nature of each of the proteins from among the families in the family list; and a grouping unit configured to perform grouping on proteins forming protein complexes in the complex pair information into sub-units each of which including proteins having a common exclusive family.

A method of evaluating interaction between protein complexes according to still another aspect of the present invention includes extracting, from a group of pair information representing a protein complex pair that includes protein complexes having interaction therebetween, a sub-unit composed of proteins having similar nature among proteins forming the protein complexes; determining whether protein attribute information of the protein included in the sub-unit is present in a group of protein attribute information identifying an attribute of protein; creating sub-unit attribute information that identifies an attribute of the subunit for each of the protein attribute information, by aggregating information on presence or absence of protein attribute information determined at the determining; generating learning data including information on presence or absence of the sub-unit attribute information and interaction attribute information identifying the interaction for each piece of the complex pair information so as to cover all sub-unit pairs formed by combination of sub-units in a protein complex giving the interaction and sub-units in a protein complex receiving the interaction; and extracting a prediction rule applied to prediction-target complex-pair information representing a prediction-target protein-complex pair of which a sub-unit pair affected by the interaction is unknown or a prediction-target protein-complex pair of which interaction is unknown, from a set of rules defining the sub-unit attribute information as a condition and the interaction attribute information as a conclusion, the rules being obtained from a set of the learning data.

A method of evaluating interaction between protein complexes according to still another aspect of the present invention includes acquiring complex pair information representing a protein complex pair affected by interaction; identifying, based on a family list in which families representing nature of protein are grouped, an exclusive family that is a representative family representing nature of each of the proteins from among the families in the family list; and grouping proteins forming protein complexes in the complex pair information into sub-units each of which including proteins having a common exclusive family.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a hardware configuration of an interaction evaluating apparatus according to an embodiment of the present invention;

FIG. 2 is a block diagram of a functional configuration of the interaction evaluating apparatus;

FIG. 3A is a schematic of a protein complex CL1 before and after forming sub-units;

FIG. 3B is a schematic of a protein complex CR2 before and after forming sub-units;

FIG. 4 is a schematic of a family database (DB) shown in FIG. 2;

FIG. 5 is a block diagram of a functional configuration of a sub-unit forming unit;

FIG. 6 is a schematic for illustrating generation of an exclusive family by an exclusive-family generating unit;

FIG. 7 is a schematic of an exclusive family DB;

FIG. 8A is a schematic of process contents of a complex-pair-information acquiring unit;

FIG. 8B is a schematic of process contents of an exclusive-family identifying unit;

FIG. 8C is a schematic of process contents of a group processing unit;

FIG. 9 is a flowchart of a sub-unit forming process by the sub-unit forming unit;

FIG. 10 is a flowchart of an exclusive family generating process;

FIG. 11 is a schematic of a gene ontology DB (GODB);

FIG. 12 is a block diagram of a functional configuration of a learning unit;

FIG. 13 is a schematic for illustrating results of protein attribute information detection and a sub-unit attribute information generation;

FIG. 14 is a schematic of a learning data set;

FIG. 15 is a chart of interaction types;

FIGS. 16A to 16C are schematics for illustrating a result of a rule match process;

FIG. 17A is a schematic for explaining a rule acquired from the result of the rule match process shown in FIG. 16A;

FIG. 17B is a schematic for explaining a rule acquired from the result of the rule match process shown in FIG. 16B;

FIG. 17C is a schematic for explaining a rule acquired from the result of the rule match process shown in FIG. 16C;

FIG. 18 is a schematic of a ranked prediction rule set;

FIG. 19 is a flowchart of a learning process by the learning unit;

FIG. 20 is a flowchart of the learning data generating process;

FIG. 21 is a flowchart of a prediction-rule extracting process;

FIG. 22 is a flowchart of a rule match process;

FIG. 23 is a flowchart of a prediction-rule determining process;

FIG. 24 is a block diagram of functional configurations of a prediction-target generating unit and an executing unit;

FIG. 25 is a schematic for illustrating complex pair information of a prediction target supplied to the sub-unit forming unit;

FIG. 26 is a schematic for illustrating information on a sub-unit complex pair to be the prediction target;

FIG. 27 is a schematic of prediction target data;

FIG. 28 is a schematic for explaining a result of conformity determination;

FIG. 29 is a schematic for explaining a result of calculation of the prediction attribute credibility degree after applying all prediction rules;

FIG. 30 is a schematic for illustrating an execution result when the interaction attribute is known;

FIG. 31 is a schematic for illustrating an execution result when the interaction attribute is unknown;

FIG. 32 is a flowchart of an execution process by the executing unit;

FIG. 33 is a schematic for illustrating interaction between protein complexes; and

FIG. 34 is a schematic of a hierarchical structure of a protein complex pair.

### DETAILED DESCRIPTION OF THE PREFERRED EMBODIMENTS

Exemplary embodiments according to the present invention will be explained in detail with reference to the accompanying drawings in the following sections 1 to 4:

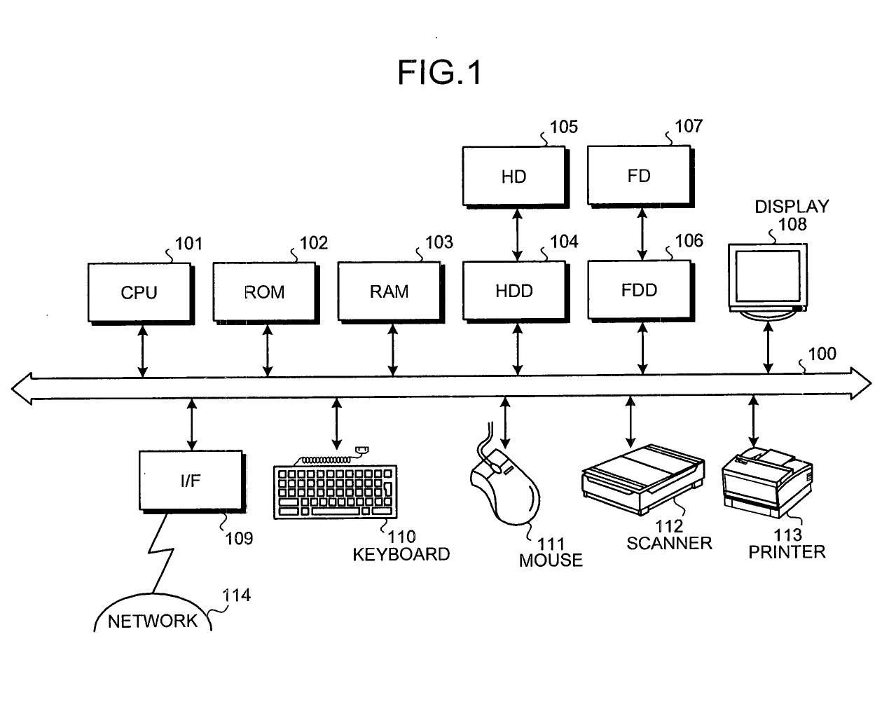

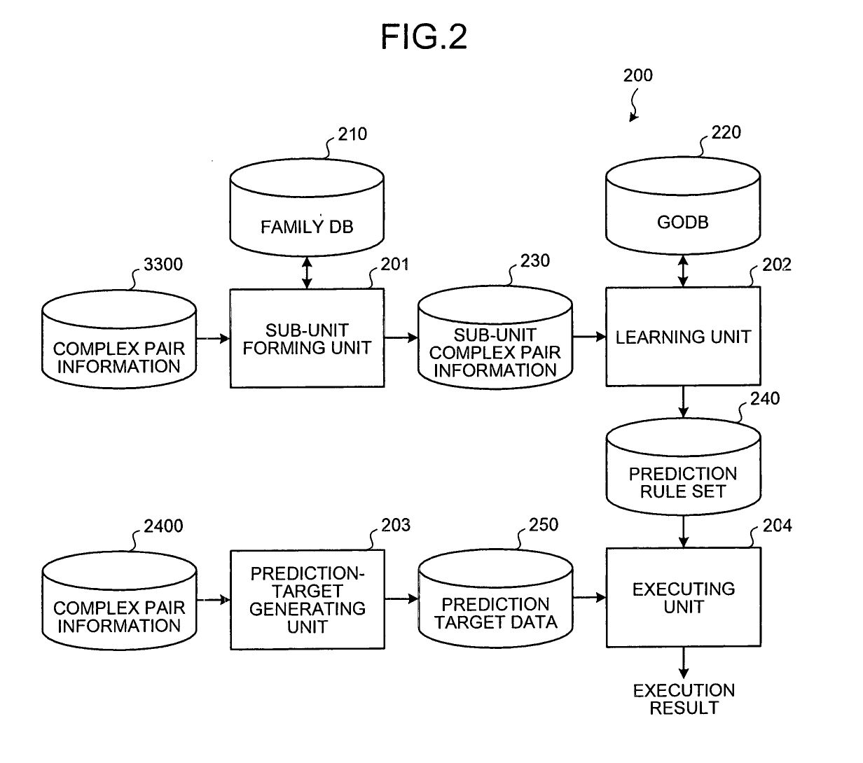

1. general outline of an interaction evaluating apparatus (FIGS. 1 and 2);

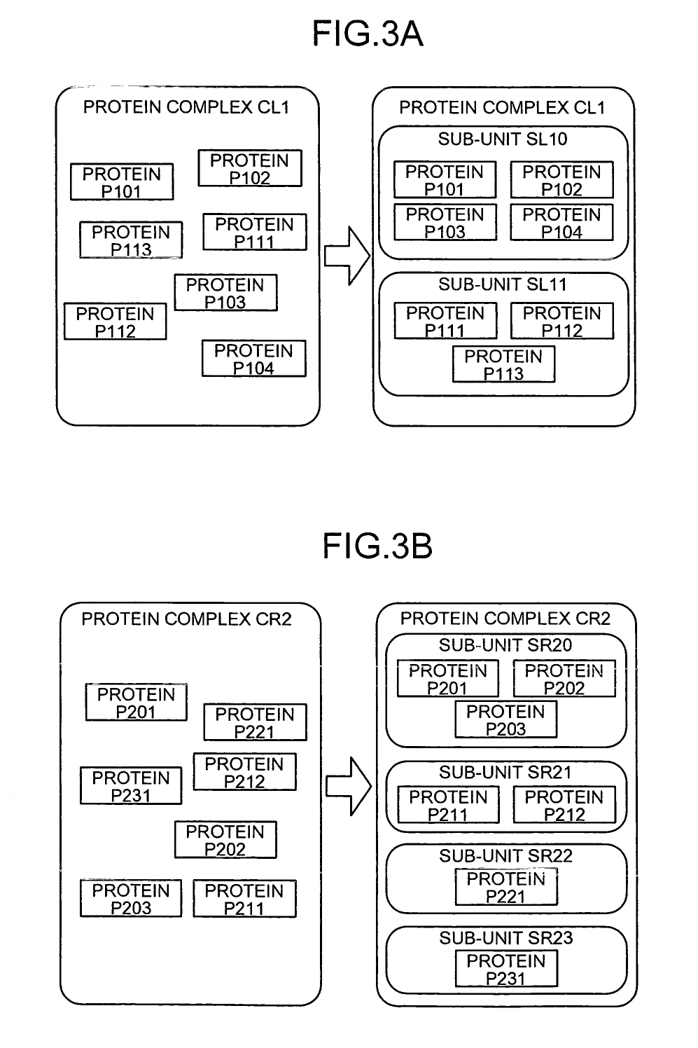

2. a sub-unit forming unit in the interaction evaluating apparatus (FIGS. 3 to 10);

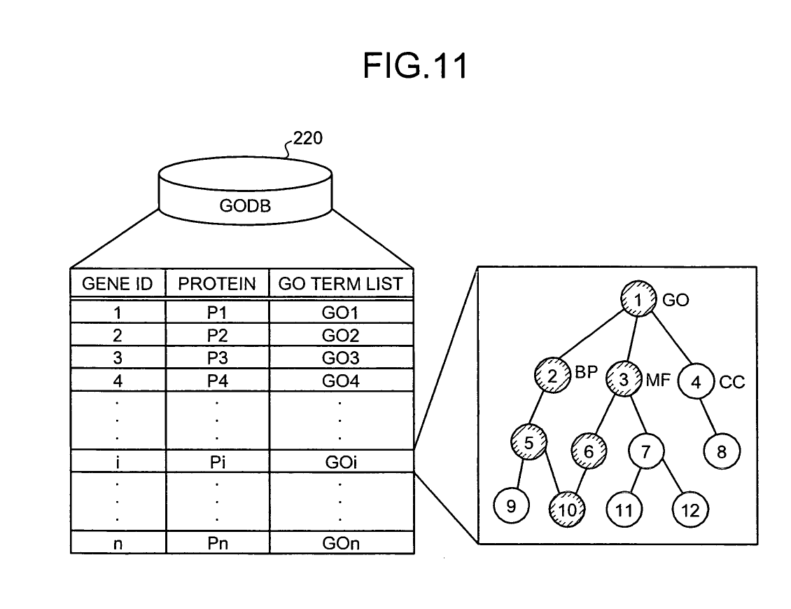

3. a learning unit in the interaction evaluating apparatus (FIGS. 11 to 23); and

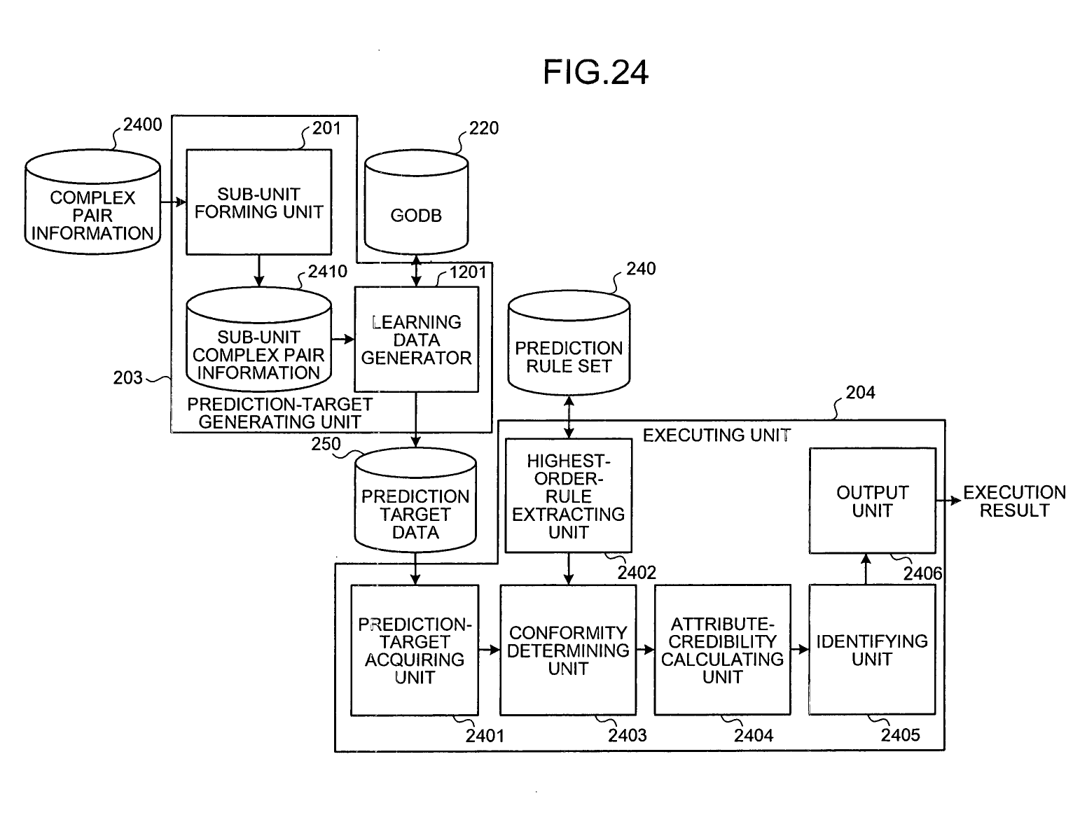

4. a prediction-target generating unit and an executing unit in the interaction evaluating apparatus (FIGS. 24 to 32).

### <1. General Outline of Interaction Evaluating Apparatus>

With regard to a general outline of an interaction evaluating apparatus, description will be made of a hardware configuration, a functional configuration, etc., of the interaction evaluating apparatus.

FIG. 1 is a block diagram showing a hardware configuration of the interaction evaluating apparatus according to the embodiment of the present invention.

As shown in FIG. 1, the interaction evaluating apparatus includes a central processing unit (CPU) 101, a read-only memory (ROM) 102, a random access memory (RAM) 103, a hard disk drive (HDD) 104, a hard disk (HD) 105, a flexible disk drive (FDD) 106, a flexible disk (FD) 107 as an example of a removable recording medium, a display 108, an interface (I/F) 109, a keyboard 110, a mouse 111, a scanner 112, and a printer 113. The components are connected to each other through a bus 100.

The CPU 101 is responsible for overall control of the interaction evaluating apparatus. The ROM 102 stores programs such as a boot program. The RAM 103 is used for a work area of the CPU 101. The HDD 104 controls read/write of data from/to the HD 105 under the control of the CPU 101. The HD 105 stores data written under the control of the HDD 104.

The FDD 106 controls read/write of data from/to the FD 107 under the control of the CPU 101. The FD 107 stores data written under the control of the FDD 106 and allows the interaction evaluating apparatus to read the data stored in the FD 107.

The removable recording medium may be a compact-disc read-only memory (CD-ROM), a compact-disc recordable (CD-R), a compact-disc rewritable (CD-RW), a magneto optical (MO) disk, a digital versatile disk (DVD), and a memory card, in addition to the FD 107. The display 108 displays a cursor, icons or tool boxes as well as data such as documents, images, and function information. This display 108 may be a cathode ray tube (CRT), a thin film transistor (TFT) liquid crystal display, and a plasma display, for example.

The I/F 109 is connected via a communication line to a network 114 such as the Internet and is connected to other apparatuses via this network 114. The I/F 109 is responsible for interfacing the network 114 with the inside of the apparatus and controls input/output of data from/to an external apparatus. The I/F 109 may be a modem and a LAN adaptor, for example.

The keyboard 110 is disposed with keys for entering characters, numeric characters, various instructions, etc., to enter data. A touch-panel type input pad, a numeric keypad, etc., may be used instead. The mouse 111 moves a cursor, selects an area or moves and resizes a window, etc. A trackball or joystick may be used instead, as long as similar functions for a pointing device are included.

The scanner 112 reads an image optically and captures image data into the interaction evaluating apparatus. The scanner 112 may have an OCR function. The printer 113 prints image data and document data. The printer 113 may be a laser printer or ink-jet printer, for example.

FIG. 2 is a block diagram of a functional configuration of an interaction evaluating apparatus according to the present invention. As shown in FIG. 2, an interaction evaluating apparatus 200 includes a family DB 210, a sub-unit forming unit 201, a GODB 220, a learning unit 202, a prediction-target generating unit 203, and an executing unit 204.

The family DB 210 is a database in which a family that is a group of proteins having similar nature. In other words, proteins belonging to one family have similar nature and it is believed that proteins in a protein complex are replaceable among the proteins in one family. Representative example of such database is InterPro (http://www.ebi.ac.uk).

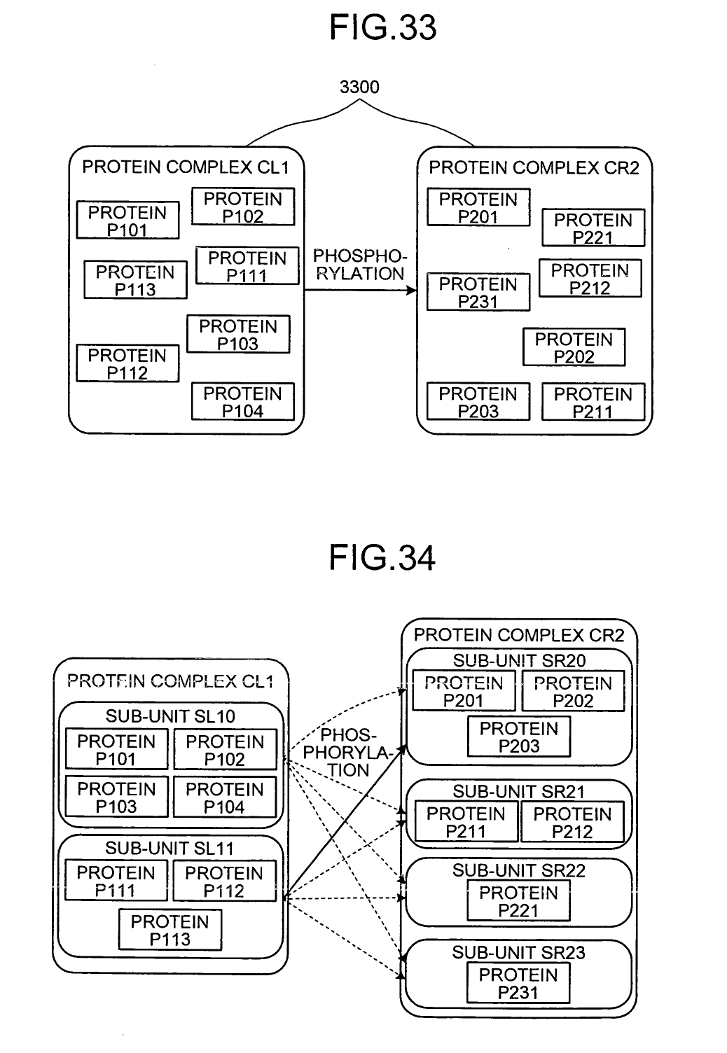

The sub-unit forming unit 201 performs a sub-unit formation processing on the complex pair information 3300 as shown in FIG. 33 to form sub-units in the complex pair information 3300, based on the family DB 210.

The aforementioned family has a hierarchical structure and includes proteins belonging to different families. The sub-unit forming unit 201 focuses on a rather large family and divides proteins in the large family into mutually exclusive families to categorize a group of proteins included in a protein complex as a sub-unit, which is an exclusive group. This exclusive group is referred to as an exclusive family. The complex pair information categorized in terms of this exclusive family is referred to as sub-unit complex pair information 230.

The gene ontology is protein attributes, such as biological processes, cellular localization, and molecule functions characterizing proteins that are added by human. The GODB 220 stores information relating to such protein attributes.

To the learning unit 202, the sub-unit complex pair information 230 is input, and a prediction rule set 240 is output from the learning unit. Specifically, the learning unit 202 adds protein attributes to the sub-units in the sub-unit complex pair information 230 based on the GODB 220. Thus, a structure to distinguish a sub-unit pair including a targeted interaction attribute from a sub-unit pair not including the targeted interaction attribute is obtained.

This structure is a prediction rule for the interaction attribute for each sub-unit. The prediction rule is expressed by “condition→conclusion”. The condition is set as “a protein attribute of a sub-unit in a protein complex is XXX” and the conclusion is obtained as “an interaction type is YYY”. The learning unit 202 outputs the prediction rules to build the prediction rule set 240. The prediction rule set 240 is stored in a recording medium such as the RAM 103 and the HD 105 shown in FIG. 1.

That is, if the prediction rule is established for any combination of sub-units in a protein complex pair, the prediction rule is assumed to be applied to the entire protein complex pair and it is considered that the interaction attribute corresponding to the prediction rule exists.

To the prediction-target generating unit 203, complex pair information 2400 of a prediction target is input. The complex pair information 2400 includes information on protein complex pairs with known interaction attributes and protein complex pairs with unknown interaction attributes. The prediction-target generating unit 203 performs a sub-unit formation processing on the complex pair information 2400 to generate prediction target data 250.

To the executing unit 204, the prediction target data 250 obtained from the prediction-target generating unit 203 is input. The executing unit 204 calculates an attribute score as an execution result based on the prediction rule set 240. The attribute sore is validity evaluation of an interaction attribute of a sub-unit pair. The prediction target data 250 is data identified by the complex pair information 2400 of which an interaction attribute between protein complexes or between sub-units is unknown.

By calculating the attribute score, for a protein complex pair of which an interaction attribute is known, the responsible sub-unit pair can be estimated. For a protein complex pair of which an interaction attribute is unknown, both the interaction attribute and the responsible sub-unit pair can be estimated at a time.

The family DB 210 and the GODB 220 realize the functions thereof with a recording medium such as the ROM 102, the RAM 103, and the HD 105 shown in FIG. 1. The sub-unit forming unit 201, the learning unit 202, the prediction-target generating unit 203, and the executing unit 204 realize the functions thereof by executing programs recorded on a recording medium such as the ROM 102, the RAM 103, and the HD 105 with the CPU 101.

Description has been made for the general outline of the interaction evaluating apparatus with reference to FIGS. 1 and 2. Description will be made for 2. the sub-unit forming unit in the interaction evaluating apparatus (FIGS. 3 to 10); 3. the learning unit in the interaction evaluating apparatus (FIGS. 11 to 23); and 4. the prediction-target generating unit and the executing unit in the interaction evaluating apparatus (FIGS. 24 to 32).

### <2. Sub-Unit Forming Unit in Interaction Evaluating Apparatus>

The sub-unit forming unit 201 forms sub-units of proteins in each protein complex identified by the complex pair information 3300. FIGS. 3A and 3B are schematics of the protein complexes CL1 and CR2 identified by the complex pair information 3300 before and after forming sub-units. The protein complexes CL1 and CR2 on the left side in FIGS. 3A and 3B are protein complexes before forming sub-units. The protein complexes CL1 and CR2 on the right side are protein complexes after forming sub-units.

In the example shown in FIG. 3A, the proteins P101 to P104 in the protein complex CL1 are grouped as the sub-unit SL10, and the proteins P111 to P113 are grouped as the sub-unit SL11.

In the example shown in FIG. 3B, the proteins P201 to P203 in the protein complex CR1 are grouped as the sub-unit SR20; the proteins P211 and P212 are grouped as the sub-unit SR21; the protein P221 is assigned as the sub-unit SR22; and the protein P231 is assigned as the sub-unit SR23.

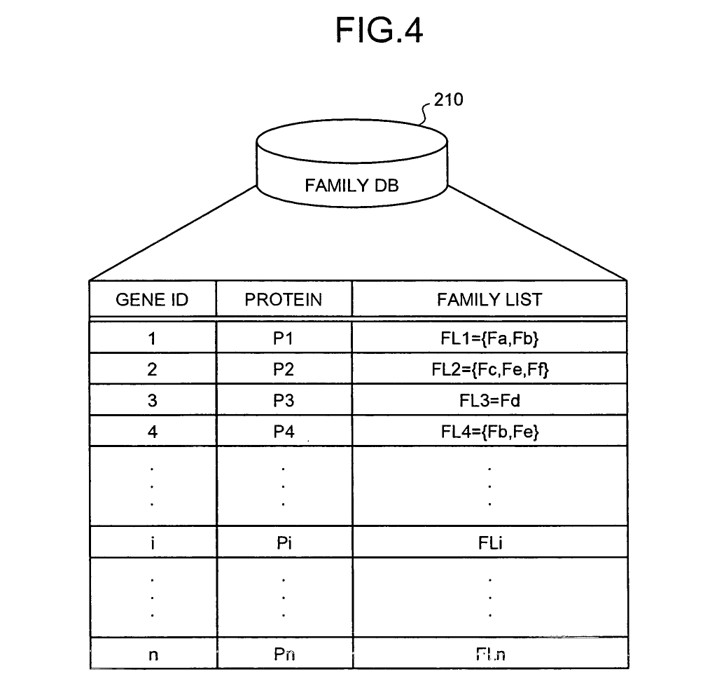

FIG. 4 is a schematic of the family DB 210 shown in FIG. 2. The family DB 210 stores a family list for each protein. Specifically, the family DB 210 stores a family list FLi for a protein Pi of a gene ID: i (i=1 to n). For example, a family list FL1 for a protein P1 is FL1={Fa, Fb}. This indicates that the protein P1 belongs to a family Fa and a family Fb. The gene ID is identification information specific to a protein.

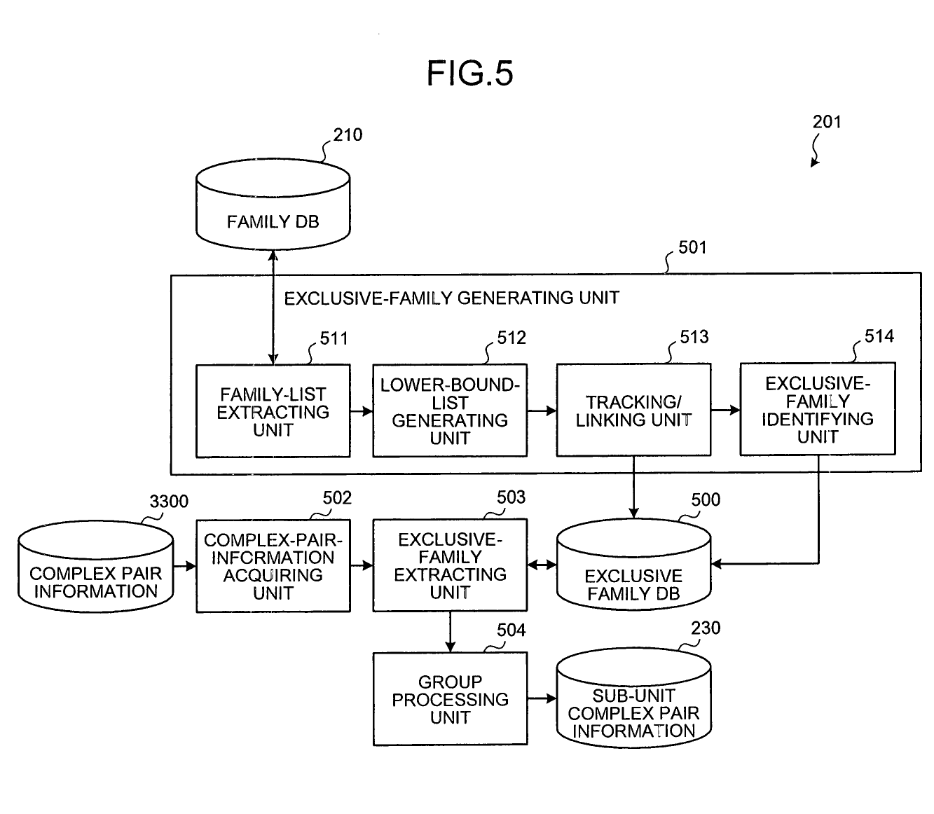

FIG. 5 is a block diagram of a functional configuration of the sub-unit forming unit 201. As shown in FIG. 5, the sub-unit forming unit 201 includes an exclusive-family generating unit 501, a complex-pair-information acquiring unit 502, an exclusive-family extracting unit 503, and a group processing unit 504.

To the exclusive-family generating unit 501, the family list FLi is input. The exclusive-family generating unit 501 identifies a family of the highest conception that represents the nature of the protein Pi. The identified family is referred to as an exclusive family. Specifically, the exclusive-family generating unit 501 includes a family-list extracting unit 511, a lower-bound-list generating unit 512, a tracking/linking unit 513, and an exclusive-family identifying unit 514.

The family-list extracting unit 511 extracts the family list FLi of the protein Pi from the family DB 210. Specifically, the extraction is performed in the order from the protein P1 with the gene ID: i=1.

The lower-bound-list generating unit 512 generates a lower-bound list from the family list FLi extracted by the family-list extracting unit 511. Specifically, the lower-bound list is generated by sequentially adding the family list FLi being extracted, and by sorting the lists in ascending order of the families, for example, in the order of alphabetical letters a, b, . . . , added to the families Fa, Fb, . . . .

The tracking/linking unit 513 performs a tracking (tracing) process and a linking process. The tracking process is a process of correlating families in one family list FLi. Specifically, families are correlated by tracking a higher-order family from a family in the family list FLi sorted in ascending order.

The linking process is a process of correlating different family lists. The linking process is performed on family lists not overlapping with each other. In the linking process, when a family list that overlaps with both of the family lists not overlapping with each other is extracted, the highest-order families in the family lists not overlapping with each other are correlated by performing the track process.

The exclusive-family identifying unit 514 identifies the exclusive family for each protein Pi from the lower-bound list including families correlated by the tracking/linking unit 513. For example, the highest-order family of the family list FLi of the protein Pi is identified as the exclusive family.

If the highest-order family in the family list FLi is used as a correlated source for the correlation with another family, the correlated destination family is identified as the exclusive family. If a single family belongs to the family list FLi and if the family is correlated with no families, the family is directly identified as the exclusive family. The identified exclusive family is stored in the exclusive family DB 500 along with the gene ID: i of the protein Pi.

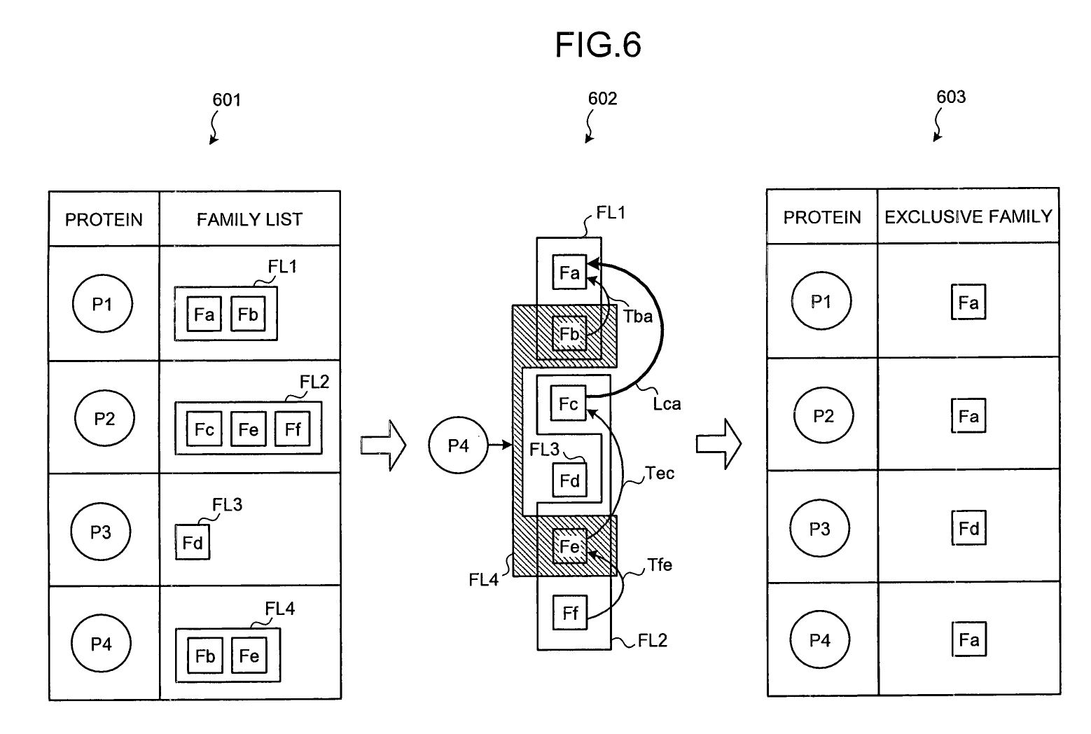

FIG. 6 is a schematic for illustrating generation of the exclusive family by the exclusive-family generating unit 501. A reference numeral 601 is a chart of family lists FL1 to FL4 of proteins P1 to P4 extracted by the family-list extracting unit 511. A reference numeral 602 represents a lower-bound list generated by the lower-bound-list generating unit 512. The lower-bound list 602 is a list at the time of extraction of the family list FL4 of the protein P4 and is sorted in an ascending order, i.e., in an analphabetic order in this case.

The lower-bound list 602 is an intermediate product for creating the exclusive family and is updated every time the family list FLi is extracted. For example, when the family list FL1 of the protein P1 is extracted, a lower-bound list including only the family list FL1 is acquired.

When the family list FL2 of the protein P2 is extracted, the family list FL2 is added to the lower-bound list including only the family list FL1. When the family list FL3 of the protein P3 is extracted, the family list FL3 is added to the lower-bound list including the family lists FL1 and FL2. When the family list FL4 of the protein P4 is extracted, the family list FL4 is added to the lower-bound list including the family lists FL1 to FL3. Thus, the lower-bound list 602 is acquired.

In the lower-bound list 602, the family list FL4 overlaps with the family list FL1. That is, a family Fb is a family belonging to the family lists FL1 and FL4. Therefore, the tracking/linking unit 513 correlates the family Fb with a family Fa by the tracking from the family Fb to the family Fa, which is higher in the ascending order in the family list FL1 (an arrow Tba in FIG. 6).

Similarly, in the lower-bound list 602, the family list FL4 overlaps with the family list FL2. A family Fe in the family list FL4 is a family belonging to the family lists FL2 and FL4. Therefore, the tracking/linking unit 513 correlates the family Fe with a family Fc by the tracking from the family Fe to the family Fc, which is higher in the ascending order in the family list FL2 (an arrow Tec in FIG. 6).

Since the family list FL2 includes a family Ff, which is lower than the family Fe in the ascending order, the tracking/linking unit 513 correlates the family Ff with the family Fe by the tracking from the family Ff to the family Fe (an arrow Tfe in FIG. 6).

In the lower-bound list 602, the family list FL1 and the family list FL2 do not overlap, while the family list FL4 overlaps with both the family lists FL1 and FL2. Therefore, the family list FL1 and the family list FL2 can be linked through the family list FL4.

Therefore, the tracking/linking unit 513 correlates the family list FL2 with the family list FL1 by the linking from the family Fc, which is high in the ascending order in the family list FL2, to the family Fa, which is high in the ascending order in the family list FL1 (an arrow Lca in FIG. 6).

A chart 603 on the right side in FIG. 6 indicates the exclusive family for each protein acquired from the lower-bound list 602. For the family list FL1 of the protein P1, FL1={Fa, Fb}, and the family Fb is correlated with the higher-order family Fa in the tracking process (the arrow Tba in FIG. 6). Therefore, the exclusive family of the protein P1 is the family Fa.

For the family list FL2 of the protein P2, FL2={Fc, Fe, Ff}; the family Ff is correlated with the higher-order family Fe in the tracking process (the arrow Tfe in FIG. 6); and the family Fe is correlated with the higher-order family Fc in the tracking process (the arrow Tec in FIG. 6). The family Fc is correlated with the family Fa in the linking process (the arrow Lca in FIG. 6). Therefore, the exclusive family of the protein P2 is the family Fa.

For the family list FL3 of the protein P3, FL3={Fd}, and since the family Fd is correlated with no family, the family Fd is directly defined as the exclusive family of the protein P3.

For the family list FL4 of the protein P4, FL4={Fb, Fe}, and each of the families Fb and Fe is correlated with the family Fa as described above. Therefore, the exclusive family of the protein P4 is the family Fa.

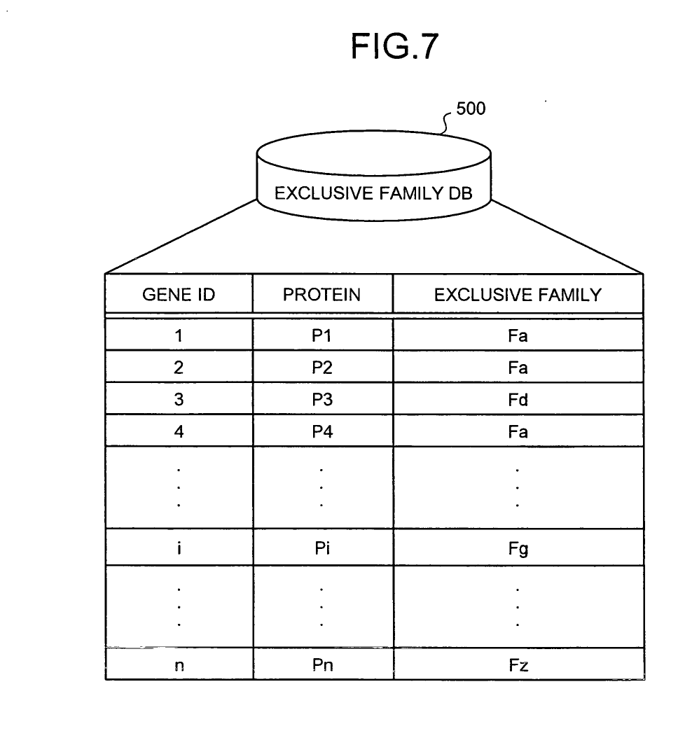

The exclusive-family generating unit 501 stores “gene ID”, “protein (name)”, and “exclusive family” that constitute one record for each protein, in the exclusive family DB 500. FIG. 7 is a schematic of the exclusive family DB 500.

The complex-pair-information acquiring unit 502 shown in FIG. 5 acquires the complex pair information 3300 shown in FIG. 33. Specifically, the complex-pair-information acquiring unit 502 reads the complex pair information 3300 specified by a user. The exclusive family identifying unit 514 identifies an exclusive family from a pair of the protein complexes CL1 and CR2 identified by the complex pair information 3300 acquired by the complex-pair-information acquiring unit 502.

Specifically, the exclusive family can be identified by using information of a protein included in the protein complexes CL1 and CR2 (e.g., gene ID: i and protein (name) Pi) as a clue to extract the exclusive family of the protein from the exclusive family DB 500.

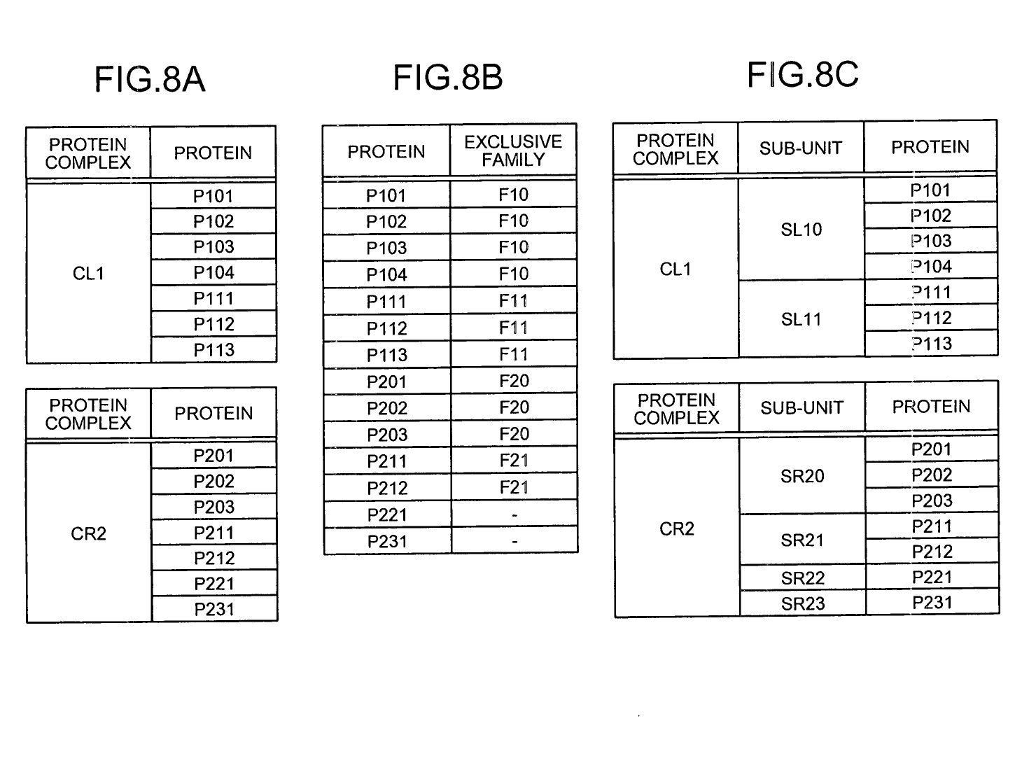

The group processing unit 504 executes grouping on proteins from which the exclusive families are identified, and makes groups of proteins for each exclusive family. The group of proteins is the sub-unit. FIGS. 8A to 8C are schematics of process contents of the complex-pair-information acquiring unit 502, the exclusive-family identifying unit 514, and the group processing unit 504 respectively. In the example shown in FIGS. 8A to 8C, the sub-units are formed by performing grouping process on the complex pair information 3300.

As shown in FIG. 8A, the complex-pair-information acquiring unit 502 acquires the complex pair information 3300. As shown in FIG. 8B, the exclusive-family identifying unit 514 identifies the exclusive families of the proteins in each of the protein complexes CL1 and CR2.

An exclusive family F10 is identified for the proteins P101 to P104; an exclusive family F11 is identified for the proteins P111 to P113; an exclusive family F20 is identified for the proteins P201 to P203; an exclusive family F21 is identified for the proteins P221, P231; and an exclusive family is not identified for the proteins P221, P231 since the exclusive family DB 500 has no corresponding exclusive family.

A shown in FIG. 8C, the group processing unit 504 organizes proteins for each of the same exclusive families to form the sub-units. That is, the proteins P101 to P104 belonging to the exclusive family F10 constitute the sub-unit SL10; the proteins P111 to P113 belonging to the exclusive family F11 constitute the sub-unit SL11; the proteins P201 Lo P203 belonging to the exclusive family F20 constitute the sub-unit SR20; and the proteins P211, P212 belonging to the exclusive family F21 constitute the sub-unit SR21. Since no exclusive family is identified for the proteins P221 and P231, different sub-units SR22, SR23 are assigned to the proteins P221, P231 to avoid the overlapping of the sub-units.

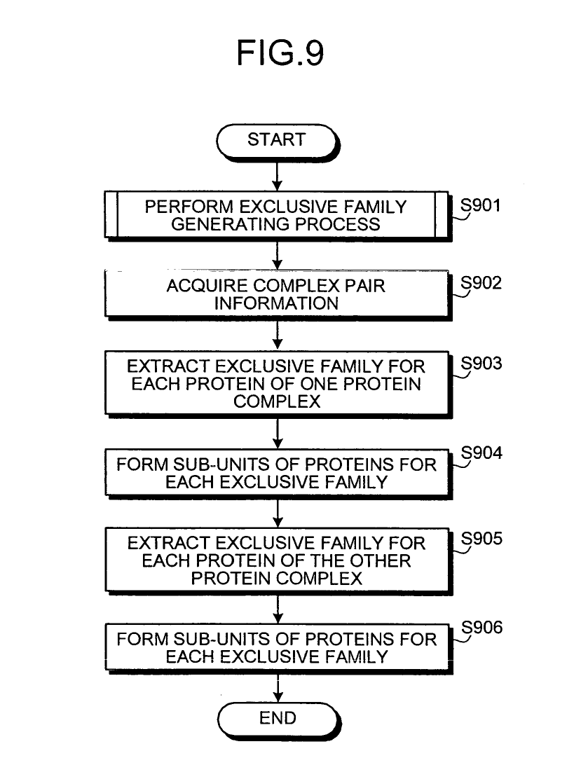

FIG. 9 is a flowchart of a sub-unit forming process by the sub-unit forming unit 201 shown in FIG. 5. The exclusive-family generating unit 501 performs the exclusive family generating process (step S901) and the complex-pair-information acquiring unit 502 acquires the complex pair information 3300 (step S902). The exclusive family is extracted from the exclusive family DB 500 for each protein of one protein complex CL1 (step S903) and the group processing unit 504 forms the sub-units by using the exclusive families to organize the proteins with the identified exclusive families (step S904).

The exclusive family is then extracted from the exclusive family DB 500 for each protein of the other protein complex CR2 (step S905) and the group processing unit 504 forms the sub-units by using the exclusive families to organize the proteins with the identified exclusive families (step S906).

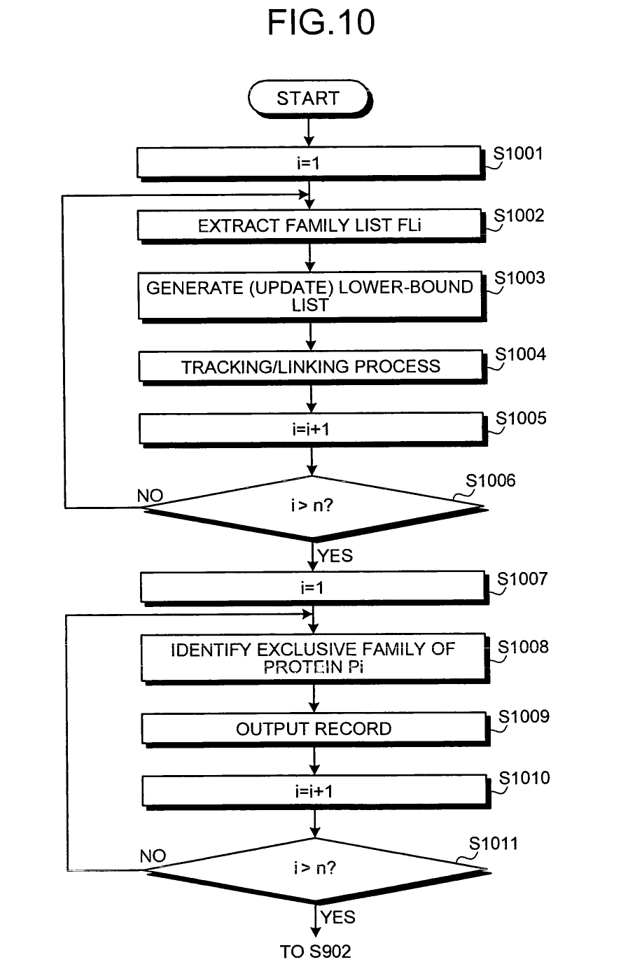

FIG. 10 is a flowchart of the exclusive family generating process shown in FIG. 9. The gene ID: i is defined as i=1 (step S1001) and the family-list extracting unit 511 extracts the family list FLi of the protein Pi from the family DB 210 (step S1002).

The lower-bound-list generating unit 512 generates (updates) the lower-bound list from the group of the extracted family lists FLi (step S1003). The tracking/linking unit 513 performs the tracking process and the linking process of the lower-bound list (step S1004) and the gene ID: i is incremented (step S1005).

If i>n is not satisfied (step S1006: NO), the procedure goes back to step S1002. On the other hand, if i>n is satisfied (step S1006: YES), the lower-bound list is completed and gene ID: i is defined as i=1 again (step S1007). The exclusive-family identifying unit 514 identifies the exclusive family of the protein Pi (step S1008).

The identified exclusive family and the information (gene ID: i and protein name) of the protein Pi are output to the exclusive family DB 500 as a record (step S1009). The gene ID: i is then incremented (step S1010). If i>n is not satisfied (step S1011: NO), the procedure goes back to step S1008. On the other hand, if i>n is satisfied (step S1011: YES), the procedure goes to step S902.

Since the aforementioned sub-unit forming unit 201 can classify groups of proteins included in the protein complexes CL1 and CR2 into the sub-units that are exclusive groups, the sub-units can be identified even if the sub-units are unknown that are groups of proteins constituting a variant. By acquiring the sub-units, the learning unit 202 can achieve the extraction of the prediction rules highly accurately.

### <3. Learning Unit in Interaction Evaluating Apparatus>

As described above, the learning unit 202 uses the sub-unit complex pair information 230 as input information and refers to the GODB 220 to output the prediction rule set 240.

FIG. 11 is a schematic of the GODB 220. As shown in FIG. 11, the GODB 220 stores a gene ontology term list (hereinafter, “GO term list”) for each protein Pi.

A GO term list GOi is attribute information of protein Pi and has a hierarchical structure in a tree stricture. Each node in the GO term list GOi represents the protein attribute information of the protein Pi. Numeric characters in the nodes are attribute identification information (attribute number) j (j=1 to m). The protein attribute information is indicated by Aj.

A node with hatching shown in FIG. 11 is the protein attribute information Aj included in the protein Pi, and a node without hatching is the protein attribute information Aj not included in the protein Pi. The protein Pi shown in FIG. 11 represents that the protein includes the protein attribute information A1 to A3, A5, A6, and A10 with the attribute number j=1 to 3, 5, 6, 10.

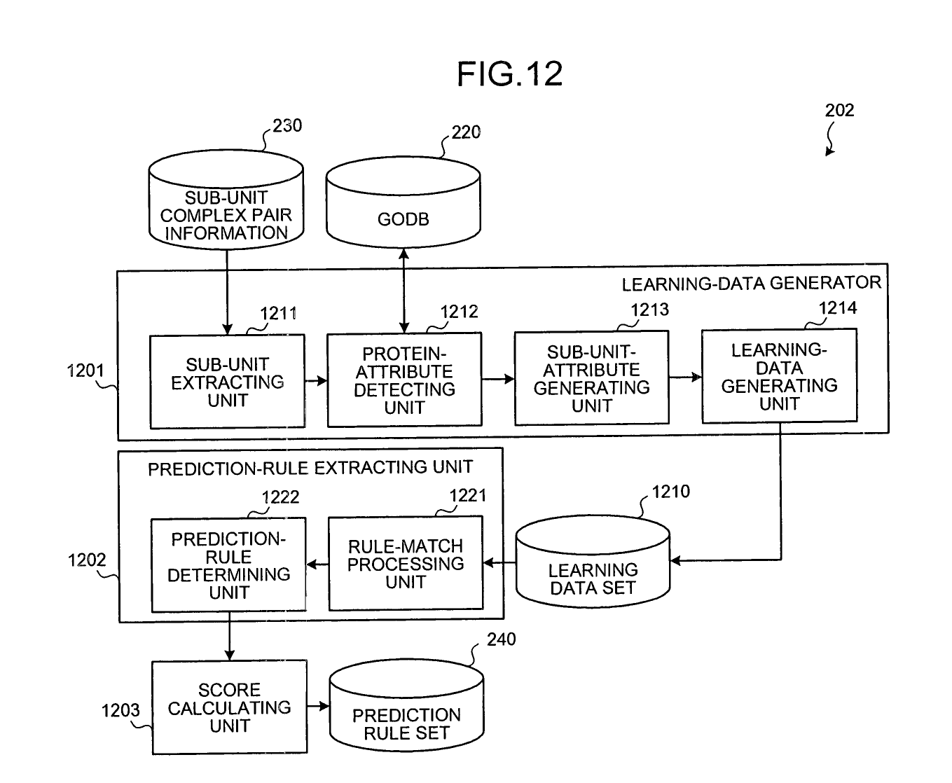

FIG. 12 is a block diagram of a functional configuration of the learning unit 202. The learning unit 202 includes a learning data generator 1201, a prediction-rule extracting unit 1202, and a score calculating unit 1203.

To the learning data generator 1201, the sub-unit complex pair information 230 is input, and the learning data generator 1201 generates learning data from which the prediction rule is extracted based on the GODB 220. Specifically, the learning data generator 1201 includes a sub-unit extracting unit 1211, a protein-attribute detecting unit 1212, a sub-unit attribute generating unit 1213, and a learning-data generating unit 1214.

The sub-unit extracting unit 1211 extracts a sub-unit from the sub-unit complex pair information 230. For example, if the extraction source is the sub-unit complex pair information 230 shown in FIG. 8C, the sub-units SL10, SL11, SR20 to SR23 are extracted.

The protein-attribute detecting unit 1212 detects from GODB 220 the protein attribute information of the proteins belonging to the sub-unit extracted by the sub-unit extracting unit 1211. For example, if the protein Pi is included in the extracted sub-unit, the protein attribute information A1 to A3, A5, A6, and A10 is detected from the GO term list GOi shown in FIG. 11 for the protein Pi.

The sub-unit attribute generating unit 1213 generates the protein attribute information relating to the sub-unit (hereinafter, “sub-unit attribute information”) from the protein attribute information Aj detected by the protein-attribute detecting unit 1212. Specifically, when focusing on all of the proteins in the sub-unit, the sub-unit attribute information for protein attribute information Aj can be acquired by aggregating certain protein attribute information Aj.

For example, when a flag is set to “1” if certain protein attribute information Aj is detected for all the proteins in the sub-unit and the flag is set to “0” if the information is not detected, all the flags of all the proteins in the sub-unit can be aggregated using a aggregating condition such as logical multiplication, logical addition, and majority decision, and the aggregation result can be used as the sub-unit attribute information for the protein attribute information Aj.

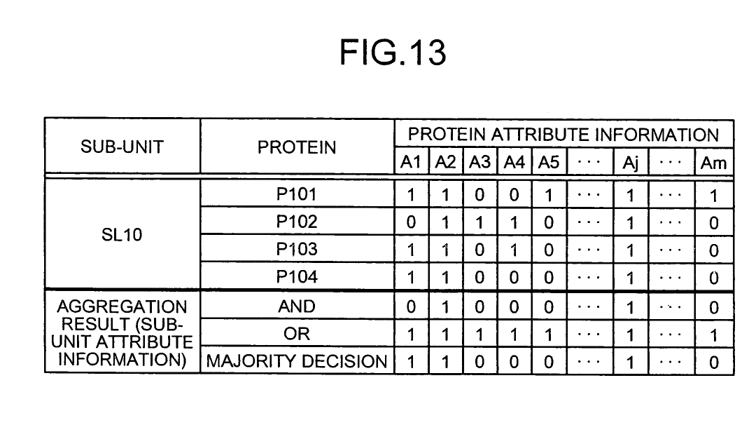

FIG. 13 is a schematic for illustrating results of protein attribute information detection and a sub-unit attribute information generation. FIG. 13 is the detection result of the proteins P101 to P104 belonging to the sub-unit SL10 for each piece of the protein attribute information Aj. As described above, the flag is set to “1” if the protein attribute information Aj is detected and the flag is set to “0” if the information is not detected.

For example, with regard to the detection result of the protein attribute information A1, since the proteins P101, P103, P104 are “1” and the protein P102 is “0”, the aggregation result is “0” if the aggregating condition is logical multiplication (AND); the aggregation result is “1” if the aggregating condition is logical addition (OR); and the aggregation result is “1” if the aggregating condition is majority decision. The aggregated protein attribute information Aj will hereinafter be indicated by sub-unit attribute information Bj.

The learning-data generating unit 1214 shown in FIG. 12 establishes all the combinations of the sub-units of one protein complex CL1 and the sub-units of the other protein complex CR2 of the sub-unit complex pair information 230 and adds interaction information between the protein complexes CL1 and CR2 to output learning data.

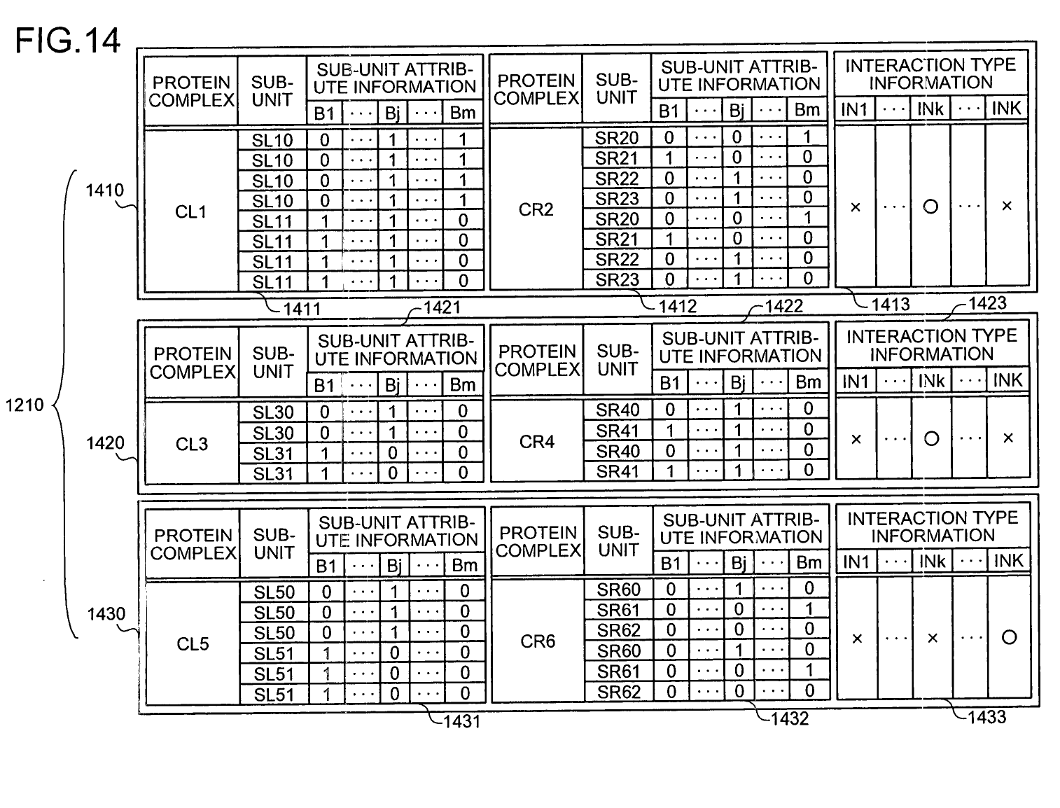

FIG. 14 is a schematic of a learning data set. A learning data set 1210 is a group of learning data (learning data 1410, 1420, and 1430 in the example shown in FIG. 14). The learning data 1410 are learning data relating to the interaction between the protein complexes CL1 and CR2; the learning data 1420 are learning data relating to the interaction between the protein complexes CL3 and CR4; and the learning data 1430 are learning data relating to the interaction between the protein complexes CL5 and CR6.

The learning data 1410 include aggregation result information 1411 and 1412. The learning data 1420 include aggregation result information 1421 and 1422. The learning data 1430 include aggregation result information 1431 and 1432.

For example, in the learning data 1410 as an example, the protein complex CL1 has the sub-units SL10, SL11 and the protein complex CR2 has the sub-units SR20 to SR23. Therefore, the learning-data generating unit 1214 establishes eight (2×4) sub-unit pairs between both protein complexes CL1 and CR2.

In FIG. 14, for convenience, the sub-unit pairs are formed by the sub-units on the same line ({SL10, SR20}, {SL10, SR21}, {SL10, SR22}, {SL10, SR23}, {SL11, SR20}, {SL11, SR21}, {SL11, SR22}, {SL11, SR23}). The same applies to the learning data 1420 and 1430.

The learning data 1410, 1420 and 1430 include interaction attribute information in addition to the aggregation result information. The interaction attribute information is taken over from the source complex pair information 3300. The interaction attribute information includes interaction attribute type information.

Specifically, a pair of the sub-units CL1 and CR2 is associated with interaction attribute type information 1413 in the learning data 1410; a pair of the sub-units CL3 and CR4 is associated with interaction attribute type information 1423 in the learning data 1420; and a pair of the sub-units CL5 and CR6 is associated with interaction attribute type information 1433 in the learning data 1430. A circle mark in the interaction attribute type information indicates a relevant interaction type.

For example, the interaction type of the learning data 1410 is an interaction type INk; the interaction type of the learning data 1420 is an interaction type INk; and the interaction type of the learning data 1430 is an interaction type INK. An interaction type ID is indicated by k (k=1 to k).

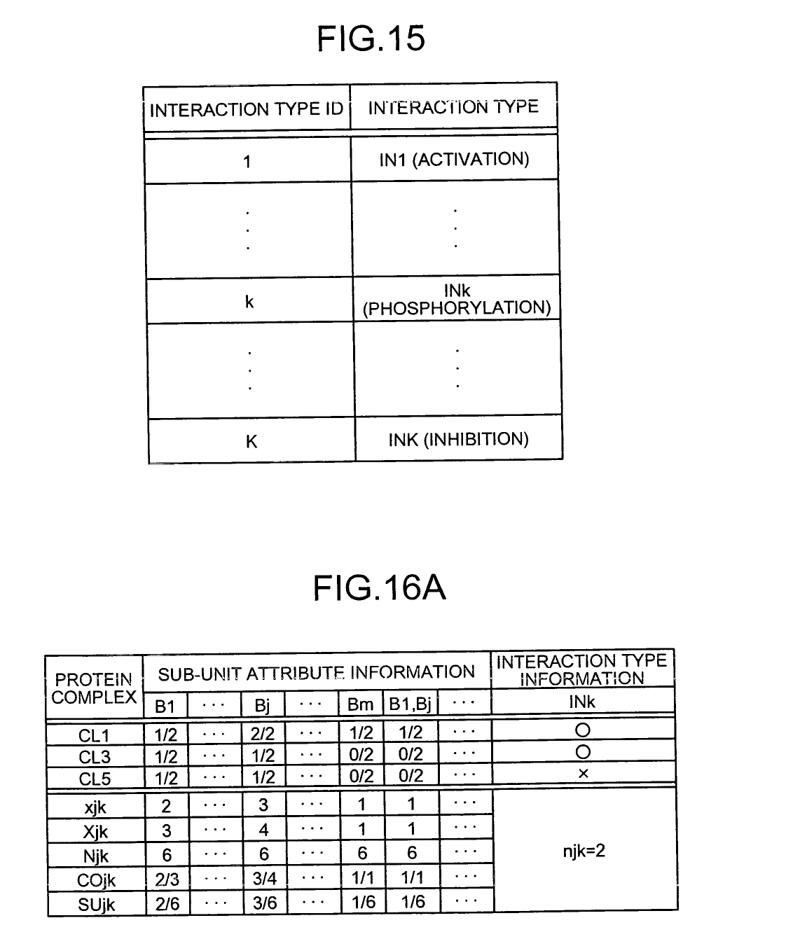

FIG. 15 is a chart of the interaction types. Referring to FIG. 15, the interaction type IN1 represents “activation”; the interaction type INk represents “phosphorylation”; and the interaction type INK represents “inhibition”.

The interaction attribute information includes interaction direction information. Referring to FIG. 14, in the learning data 1410, 1420, and 1430, the aggregation result information 1411, 1421, and 1431 of the protein complexes CL1, CL3, and CL5 is the sub-unit attribution information of the protein complexes giving the interactions, and the aggregation result information 1412, 1422, and 1432 of the protein complexes CR2, CR4, and CR6 is the sub-unit attribution information of the protein complexes receiving the interactions. In FIG. 14, the interaction direction information is identified by the positions of the aggregation result information 1411, 1412, 1421, 1422, 1431, and 1432 in this way, for convenience.

The prediction-rule extracting unit 1202 extracts the prediction rule from the learning data set 1210. Specifically, the prediction-rule extracting unit 1202 includes a rule-match processing unit 1221 and a prediction-rule determining unit 1222. The prediction rule is represented by “condition→conclusion” and three types of the conditions are assumed because a protein complex pair is concerned.

The three types includes the case in which only the sub-unit attribute information of the sub-units in the protein complex giving the interaction is used in the “condition”, the case in which only the sub-unit attribute information of the sub-units in the protein complex receiving the interaction is used in the “condition”, and the case in which sub-unit information of the sub-units in the both protein complexes is used in the “condition”.

The rule-match processing unit 1221 applies the aforementioned three types of the “conditions” to perform a rule match process. In the rule match process, so-called association analysis is performed. A parameter relating to the association analysis is obtained and this parameter is used to calculate a credibility degree and a support degree.

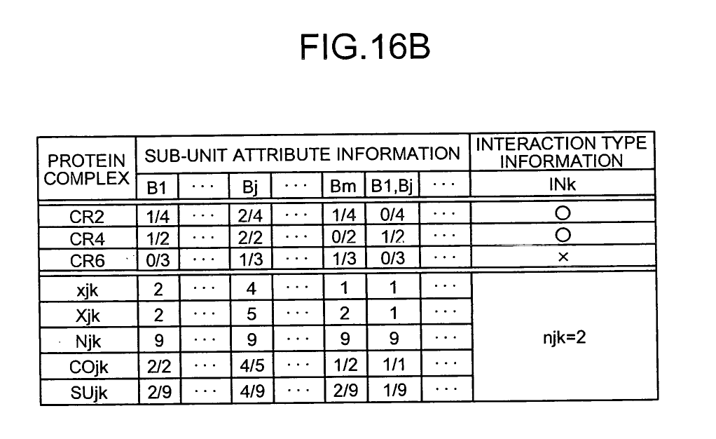

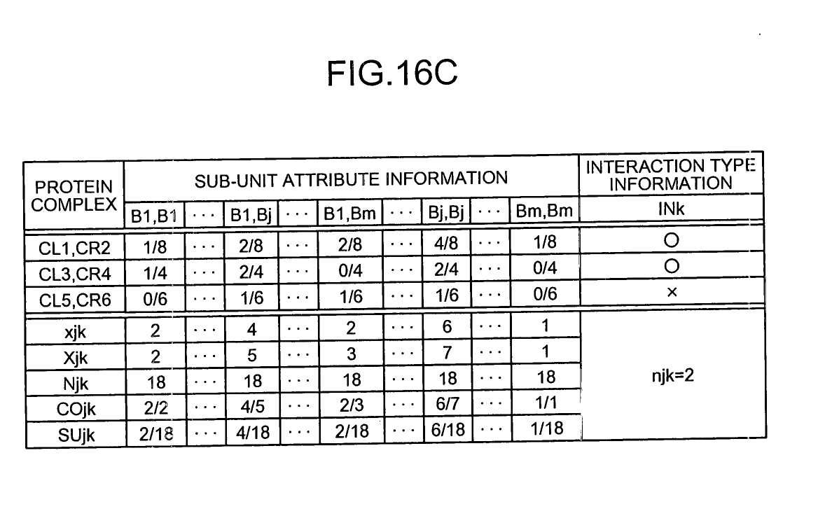

FIGS. 16A to 16C are schematics for illustrating a result of a rule match process. The results shown in FIGS. 16A to 16C are based on the learning data 1410, 1420, and 1430 shown in FIG. 14.

The rule match process result of FIG. 16A is obtained with the use of the aggregation result information 1411, 1421, and 1431 and the interaction type information 1413, 1423, and 1433 on the interaction giving side of the learning data 1410, 1420, and 1430. For convenience, the interaction type information 1413, 1423, and 1433 are limited to the interaction type INk in this description.

The rule match process result of FIG. 16B is obtained with the use of the aggregation result information 1412, 1422, and 1432 and the interaction type information 1413, 1423, and 1433 on the interaction receiving side of the learning data 1410, 1420, and 1430. The rule match process result of FIG. 16C is obtained with the use of all the learning data 1410, 1420, and 1430 shown in FIG. 14. The rule match process result of FIG. 16A will be described here as a representative of the results.

First, the detection number of the sub-unit is counted for each piece of the sub-unit attribute information Bj. Specifically, when focusing on the sub-unit attribute information B1 of the protein complex CL1 in the aggregation result information 1411 of the learning data 1410, the flag of the sub-unit SL10 is “0” since the sub-unit attribute information B1 is not detected for the sub-unit SL10 and the flag of the sub-unit SL11 is “1” since the sub-unit attribute information B1 is detected for the sub-unit SL11.

The total number of the sub-units is two in the aggregation result information 1411 (the sub-unit S10 and the sub-unit S11), and since the detected sub-unit with the flag of “1” is the sub-unit S11, the detection number is one. In FIG. 16A, “½” is entered for (the detection number)/(the total sub-unit number) of the protein complex CL1.

The detection number of the sub-unit of a plurality of pieces of the sub-unit attribute information is counted for each protein complex CL1, CL3, and CL5. Specifically, when focusing on the sub-unit attribute information B1, Bj of the protein complex CL1 in the aggregation result information 1411 of the learning data 1410, the flags of the sub-unit SL10 are “0” since the sub-unit attribute information B1, and Bj is not detected for the sub-unit SL10 and the flags of the sub-unit SL11 is “1” since the sub-unit attribute information B1, Bj is detected for the sub-unit SL11.

The total number of the sub-units is two in the aggregation result information 1411 (the sub-unit S10 and the sub-unit S11), and since the detected sub-unit with the flag of “1” is the sub-unit S11, the detection number is one. In FIG. 16A, “½” is entered for (the detection number)/(the total sub-unit number) of the protein complex CL1. Such a process is also performed for each protein complex CL3 and C15.

A parameter for calculating the credibility degree is calculated. The credibility degree is a rate of the occurrence of “conclusion” when “condition” is generated and can be expressed by the following equation.

COj k=xjk/Xjk (1)

In the case of the sub-unit attribute information Bj and the interaction type INk, Cojk is the credibility degree, xjk is the detection number including “condition” and “conclusion”, and Xjk is the detection number including “condition”.

Specifically, the detection number Xjk is the total detection number of the sub-unit attribute information Bj, which is the condition. For example, in the protein attribute information Bj, the detection number of the protein complex CL1 is “2”; the detection number of the protein complex CL3 is “1”; the detection number of the protein complex CL5 is “1”; and, therefore, Xjk=4 is achieved.

On the other hand, the detection number xjk must also satisfy “conclusion”. Therefore, in FIG. 16A, the detection number is counted only when the interaction type INk is indicated by a “circle mark” and the detection number is not counted when the interaction type INk is indicated by “x”. For example, in the protein attribute information Bj, since the detection number “2” of the protein complex CL1 and the detection number “1” of the protein complex CL3 are counted and the detection number “1” of the protein complex CL5 is not counted, xjk=3 is achieved. Therefore, from the Equation 1, the credibility degree COjk is ¾.

Although it is important to acquire the credibility degree COjk for value judgment of the extracted prediction rule, even when the credibility degree COjk is high, the extracted prediction rule has the extremely low number of occurrences if a support degree SUjk is low. Therefore, it is important to calculate and evaluate the support degree SUjk.

The support degree SUjk is a rate of the detection number concurrently satisfying “condition” and “conclusion” to the total sub-unit number and can be expressed by the following Equation 2.

SUjk=xjk/Njk (2)

In the case of the sub-unit attribute information Bj and the interaction type INk, Njk is the total sub-unit number in the sub-unit attribute information Bj. Since the total sub-unit number of each protein complex CL1, CL3, and CL5 is “2”, the total sub-unit number Njk in the sub-unit attribute information Bj is Njk=6. On the other hand, njk is the number of “conclusion” corresponding to “condition”. In FIG. 16A, this corresponds to the number of times when the interaction type INk is used as “conclusion”, i.e., the number of the circle marks (njk=2) in the example shown in FIG. 16A.

In the example shown in FIG. 16C, consideration must be given to the sub-unit attribute information B1 to Bm of the protein complexes CL1, CL3, and CL5 giving the interaction and the sub-unit attribute information B1 to Bm of the protein complexes CR2, CR4, and CR6 receiving the interaction. That is, m×m combinations of sub-unit attribute information {B1, B1}, . . . , {B1, Bj}, . . . , {B1, Bm}, . . . , {Bj, B1}, . . . , {Bj, Bj}, . . . , {Bj, Bm}, . . . , {Bm, B1}, . . . , {Bm, Bj}, . . . , {Bm, Bm} exist for each protein complex pair {CL1, CR2}, {CL3, CR4}, {CL5, CR6}.

In the example shown in FIG. 16C, the sub-unit attribute information {B1, Bj} surrounded by heavy lines indicates that B1 is the sub-unit attribute information of the protein complexes CL1, CL3, CL5 giving the interaction and that Bj is the sub-unit attribute information of the protein complexes CR2, CR4, and CR6 receiving the interaction.

More specifically, for example, in the protein complex pair {CL1, CR2}, with regard to the number of sub-unit pairs satisfying that the sub-unit attribute information B1 exists in the protein complex CL1 and that the sub-unit attribute information Bj exists in the protein complex pair CR2, referring to FIG. 14, such sub-unit pairs are two patterns {SL11, SR22}, {SL11, SR23} among eight combinations (total sub-unit pair number) of the protein complex pair {CL1, CR2}. Therefore, “ 2/8” is entered in the example shown in FIG. 16C.

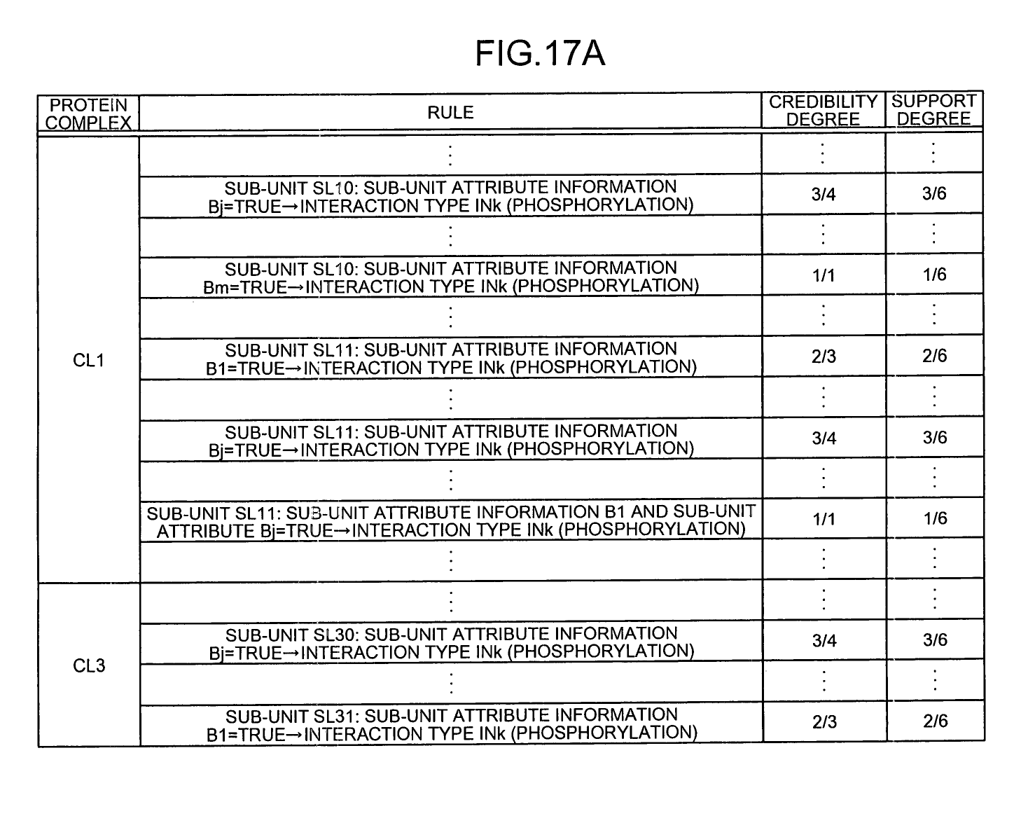

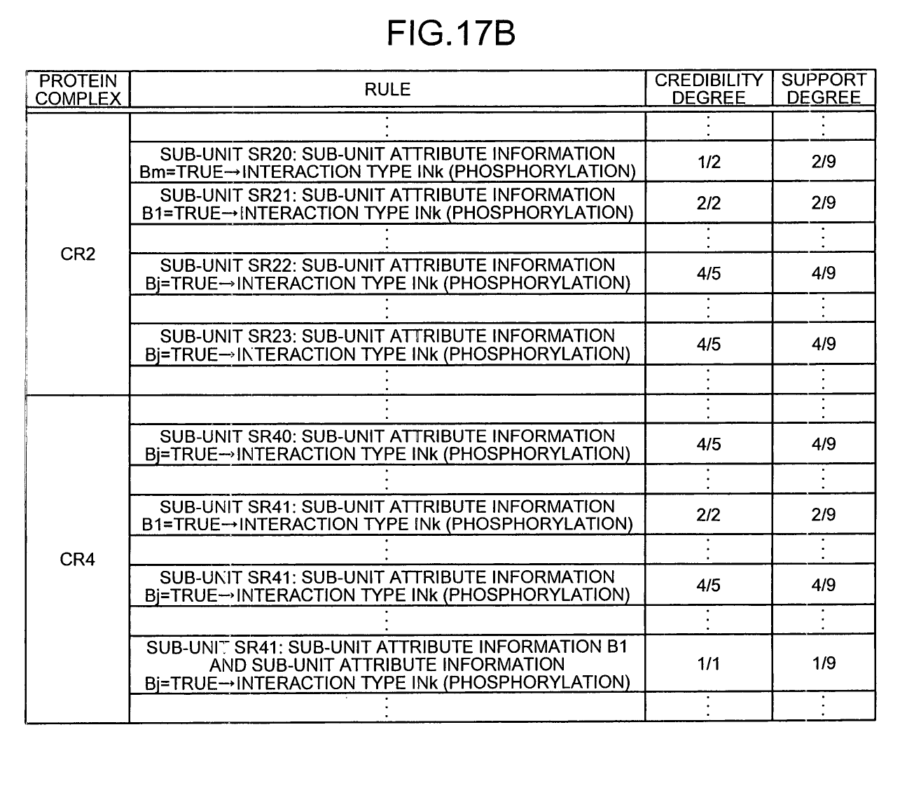

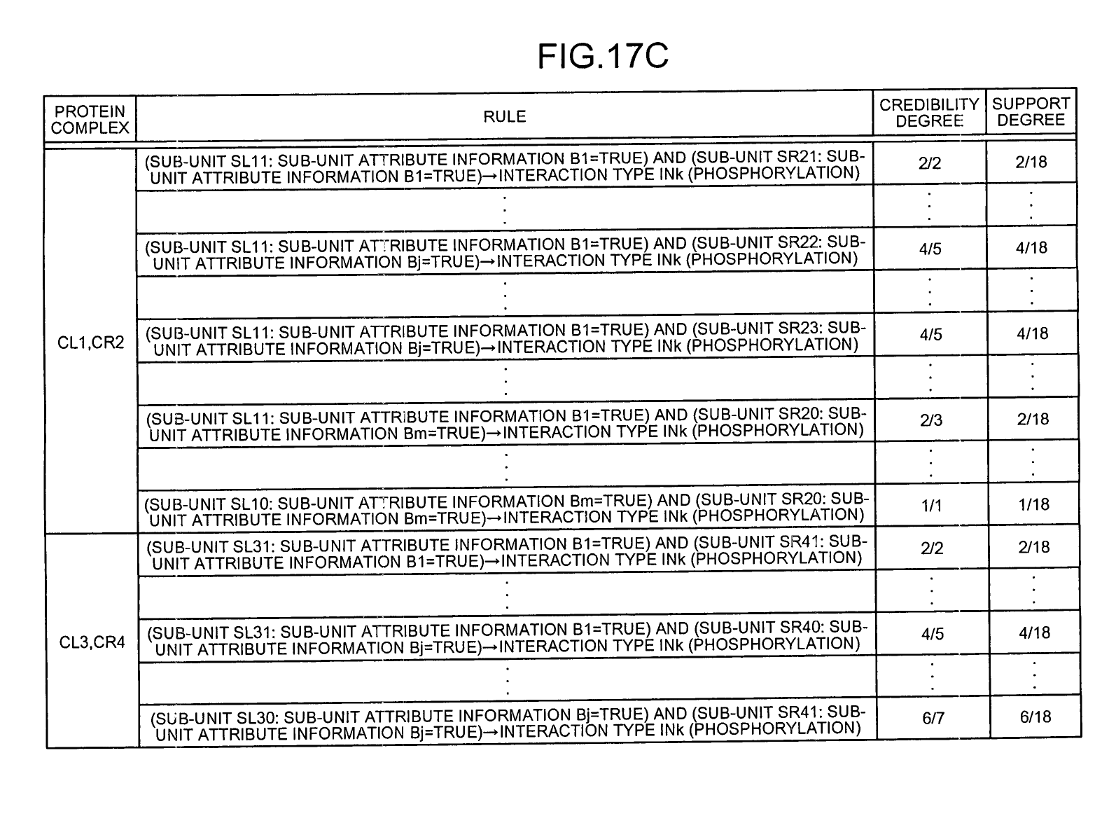

FIG. 17A is a schematic for explaining a rule acquired from a result of the rule match process shown in FIG. 16A; FIG. 17B is schematic for explaining a rule acquired from a result of the rule match process shown in FIG. 16B; and FIG. 17C is a schematic for explaining a rule acquired from a result of the rule match process shown in FIG. 16C.

The prediction-rule determining unit 1222 determines the prediction rule based on the credibility degree COjk and the support degree SUjk acquired by the rule-match processing unit 1221. Specifically, in the case of the sub-unit attribute information Bj and the interaction type INk, it is determined whether the credibility degree COjk is equal to or greater than a threshold value COt with regard to a rule meaning that “if sub-unit attribute information of one sub-unit is Bj, the interaction type is INk” (hereinafter, “Bj→INk”). If the credibility degree COjk is equal to or greater than the threshold value COt, “Bj-INk” is determined as the prediction rule.

The prediction accuracy is improved by considering the support degree Sujk. Therefore, if the credibility degree COjk is equal to or greater than the threshold value COt, it may be determined whether the support degree SUjk is equal to or greater than a threshold value SUt. If the credibility degree COjk is equal to or greater than the threshold value COt and if the support degree SUjk is equal to or greater than a threshold value SUt, “Bj→INk” may be determined as the prediction rule.

The score calculating unit 1203 calculates a score of the prediction rule determined by the prediction-rule determining unit 1222. Specifically, for example, the score calculating unit 1203 calculates a log-of-odds (LOD) score. In the case of the sub-unit attribute information Bj and the interaction type INk, the rate of the interaction type INk is njk/Njk. The LOD score is a score for evaluating how great the credibility degree COj is relative to the rate of the interaction type INk (njk/Njk).

That is, the LOD score represents the extent of abnormality about likelihood representing how frequently the prediction rule occurs, and the greater the LOD score is, the better the prediction rule reflects characteristics. The LOD score can be calculated by the following Equation 3.

$$LODscore = {log}_{10} \frac{{}_{n}^{}{C}{}_{x}^{} \times {}_{N - n}^{}{C}{}_{X - x}^{}}{{}_{N}^{}{C}{}_{X}^{}} \qquad ( 3 )$$

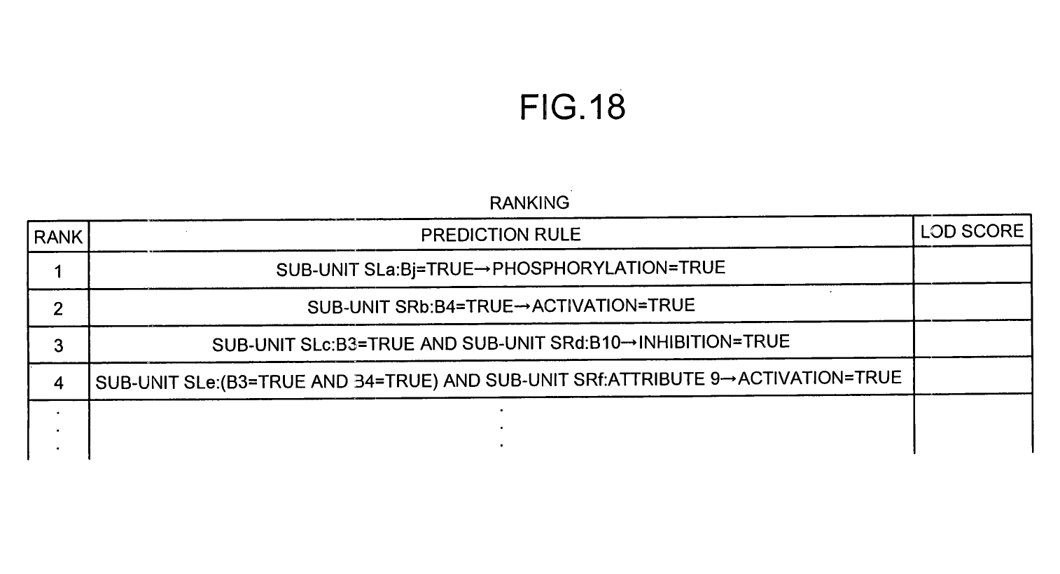

The score calculating unit 1203 sorts the prediction rules in the order from the highest calculated score to rank the prediction rules. FIG. 18 is an explanatory diagram of a ranked prediction rule set 240. In this way, the learning unit 202 can acquire the ranked prediction rule set 240.

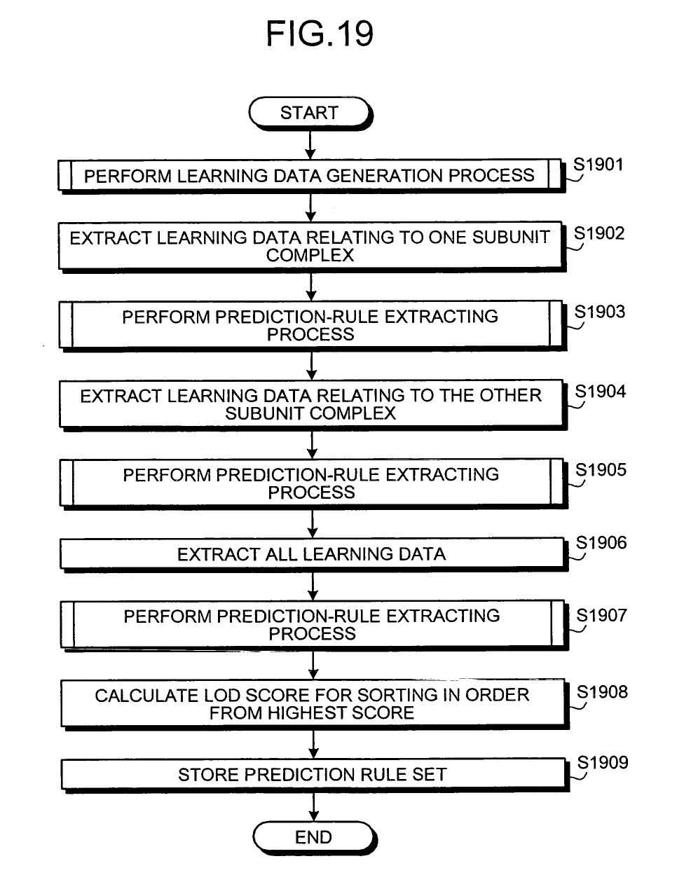

FIG. 19 is a flowchart of a learning process by the learning unit 202. The learning data generator 1201 performs a learning data generation process (step S1901). Learning data relating to one sub-unit protein complex giving the interaction are extracted from the learning data (step S1902).

Specifically, for example, in the learning data set 1210 shown in FIG. 14, the aggregation result information 1411, 1421, and 1431 and the interaction type information 1413, 1423, and 1433 are extracted. The prediction-rule extracting unit 1202 performs the prediction rule extraction process (step S1903). Learning data relating to the other sub-unit protein complex receiving the interaction are then extracted from the learning data (step S1904).

For example, in the learning data set 1210 shown in FIG. 14, the aggregation result information 1412, 1422, and 1432 and the interaction type information 1413, 1423, and 1433 are extracted. The prediction-rule extracting unit 1202 performs a prediction rule extraction process (step S1905). All the learning data are then extracted (step S1906) and the prediction-rule extracting unit 1202 performs the prediction rule extraction process (step S1907).

The score calculating unit 1203 calculates the LOD score and sorts the prediction rules in the order from the highest score to rank the prediction rules (step S1908). The ranked prediction rule set 240 is stored (step S1909).

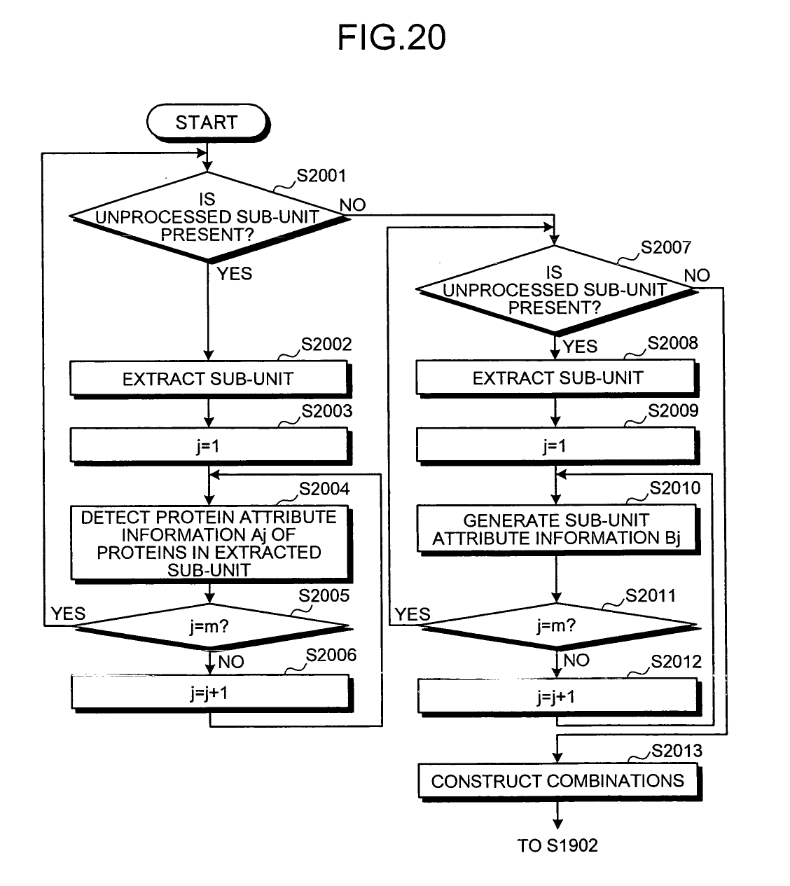

FIG. 20 is a flowchart of a learning data generating process. It is determined in a group of the sub-unit complex pair information 230 whether an unprocessed sub-unit exists for the detection of the protein attribution information Aj (step S2001). If the unprocessed sub-unit exists (step S2001: YES), the unprocessed sub-unit is extracted (step S2002).

The attribution number j of the protein attribution information Aj is set to j=1 (step S2003), and by referring to the GODB 220, the protein-attribute detecting unit 1212 detects the protein attribute information Aj of the proteins in the extracted sub-unit (step S2004). It is determined whether j=m is achieved (step S2005), and if j=m is not achieved (step S2005: no), j is incremented (step S2006) and the procedure goes back to step S2004.

On the other hand, if j=m is achieved (step S2005: YES), the procedure goes back to step S2001. At step S2001, if the unprocessed sub-unit does not exist (step S2001: NO), it is determined whether an unprocessed sub-unit exists for the detection of the protein attribution information Bj (step S2007). If the unprocessed sub-unit exists (step S2007: YES), the unprocessed sub-unit is extracted (step S2008).

The attribution number j of the protein attribution information Bj is set to j=1 (step S2009), the sub-unit attribute generating unit 1213 generates the sub-unit attribute information Bj (step S2010).

It is then determined whether j=m (m is the maximum attribute number) is achieved (step S2011), and if the j=m is not achieved (step S2011: NO), j is incremented (step S2012) and the procedure goes back to step S2010.

On the other hand, if j=m is achieved (step S2011: YES), the procedure goes back to step S2007. At step S2007, if the unprocessed sub-unit does not exist (step S2007: NO), the learning-data generating unit 1214 can perform combination construction (step S2013) to acquire the learning data set 1210 shown in FIG. 14.

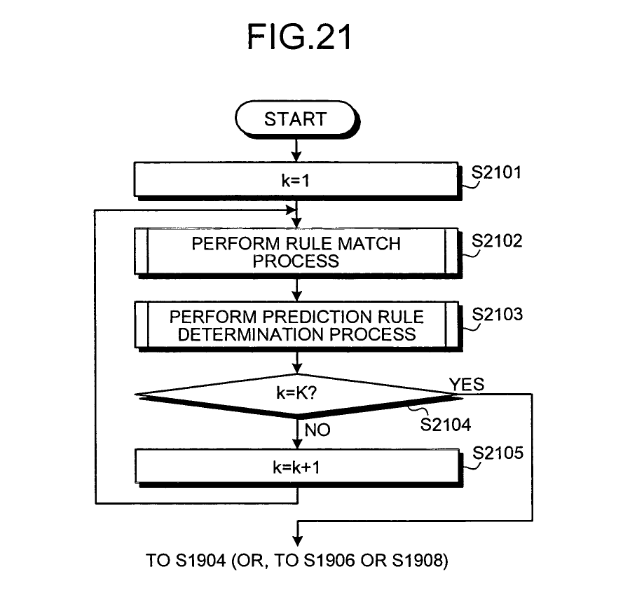

FIG. 21 is a flowchart of a prediction-rule extracting process. The interaction type ID: k is set to k=1 (step S2101), the rule-match processing unit 1221 performs the rule match process for the interaction type INk (step S2102).

The prediction-rule determining unit 1222 performs the prediction rule determination process (step S2103). It is determined whether k=K is achieved (step S2104), and if k=K is not achieved (step S2104: NO), k is incremented (step S2105) and the procedure goes back to the rule match process at step S2102. On the other hand, if k=K is achieved (step S2104: YES), the procedure goes to step S1904.

If this prediction rule extraction process is a process performed at step S1905, the procedure goes to step S1906, and if this process is performed at step S1907, the procedure goes to step S1908.

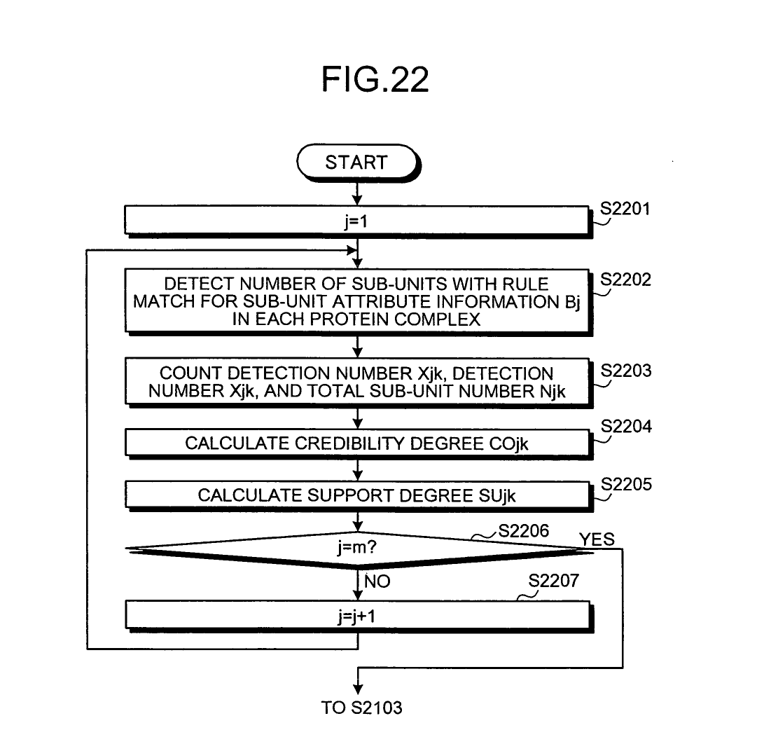

FIG. 22 is a flowchart of a rule match process. First, j=1 is defined (step S2201), and the number of sub-units with rule match is detected for the sub-unit attribute information Bj in each protein complex (step S2202). The detection result shown in the upper half of FIG. 13 is acquired with this process.

The detection number xjk, the detection number Xjk, and the total sub-unit number Njk are counted (step S2203). These parameters are used to calculate the credibility degree COjk (step S2204) and the support degree SUjk (step S2205).

It is then determined whether j=m is achieved (step S2206), and if j=m is not achieved (step S2206: NO), j is incremented (step S2207) and the procedure goes back to step S2202. On the other hand, if j=m is achieved (step S2206: YES), the procedure goes to step S2103.

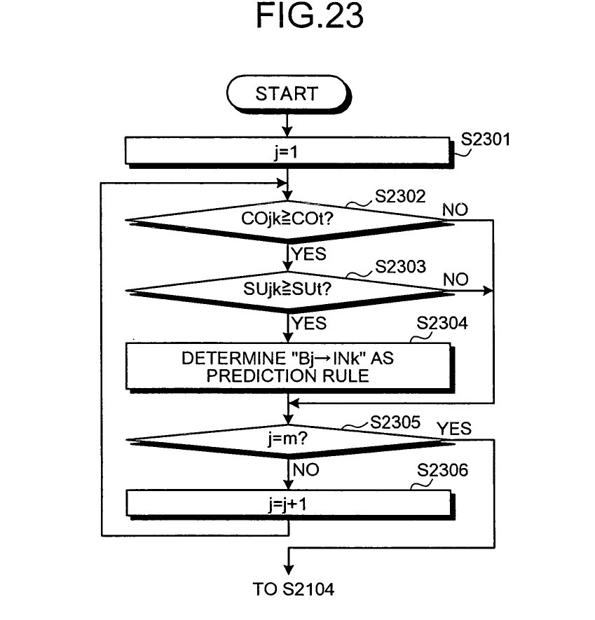

FIG. 23 is a flowchart of a prediction rule determining process. First j=1 is defined (step S2301), and it is determined whether COjk≧COt is achieved (step S2302). If COjk≧COt is not achieved (step S2302: NO), the procedure goes to step S2305.

On the other hand, If COjk≧COt is achieved (step S2302: YES), it is determined whether SUjk≧SUt is achieved (step S2303). If SUjk≧SUt is not achieved (step S2303: NO), the procedure goes to step S2305.

If SUjk≧SUt is achieved (step S2303: YES), the rule “Bj→INk” is determined as the prediction rule (step S2304), and the procedure goes to step S2305. At step S2305, it is determined whether j=m is achieved, and if j=m is not achieved (step S2305: NO), j is incremented (step S2306) and the procedure goes back to step S2302. If j=m is achieved (step S2305: YES), the procedure goes to step S2104.

In the aforementioned rule match process (step S2102), for the convenience of description, the number of sub-units with the rule match is detected for one sub-unit attribute information Bj at step S2202, and the case of using a plurality of pieces of the sub-unit attribute information shown in FIGS. 16A to 16C is omitted for the convenience of description (e.g., {B1, Bj} of FIGS. 16A and 16B and the combination of the sub-unit attribute information of FIG. 16C). However, the detection numbers xjk, Xjk and the total sub-unit numbers Njk may be detected and the credibility degrees Cojk and the support degrees SUjk may be calculated as described above for a plurality of pieces of the sub-unit attribute information.

In this way, the aforementioned learning unit 202 can extract the reliable rule from the rules acquired by giving the sub-unit complex pair 230.

### <4. Prediction-Target Generating Unit and Executing Unit in Interaction Evaluating Apparatus>

As describe above, to the prediction-target generating unit 203, the complex pair information 2400 of a prediction target is input. The prediction-target generating unit 203 makes sub-units of the complex pair information 2400 and finally creates the prediction target data 250.

To the executing unit 204, the prediction target data 250 is input, and the executing unit 204 refers to the prediction rule set 240 acquired by the learning unit 202 to calculate the execution result, i.e., the attribute score, which is validation evaluation of an interaction attribute of a sub-unit pair.

FIG. 24 is a block diagram of functional configurations of the prediction-target generating unit 203 and the executing unit 204. The prediction-target generating unit 203 includes the sub-unit forming unit 201 and the learning data generator 1201 used in the learning unit 202. Specifically, the sub-unit forming unit 201 captures the complex pair information 2400 relating to protein complex pairs with known interaction attributes and protein complex pairs with unknown interaction attributes.

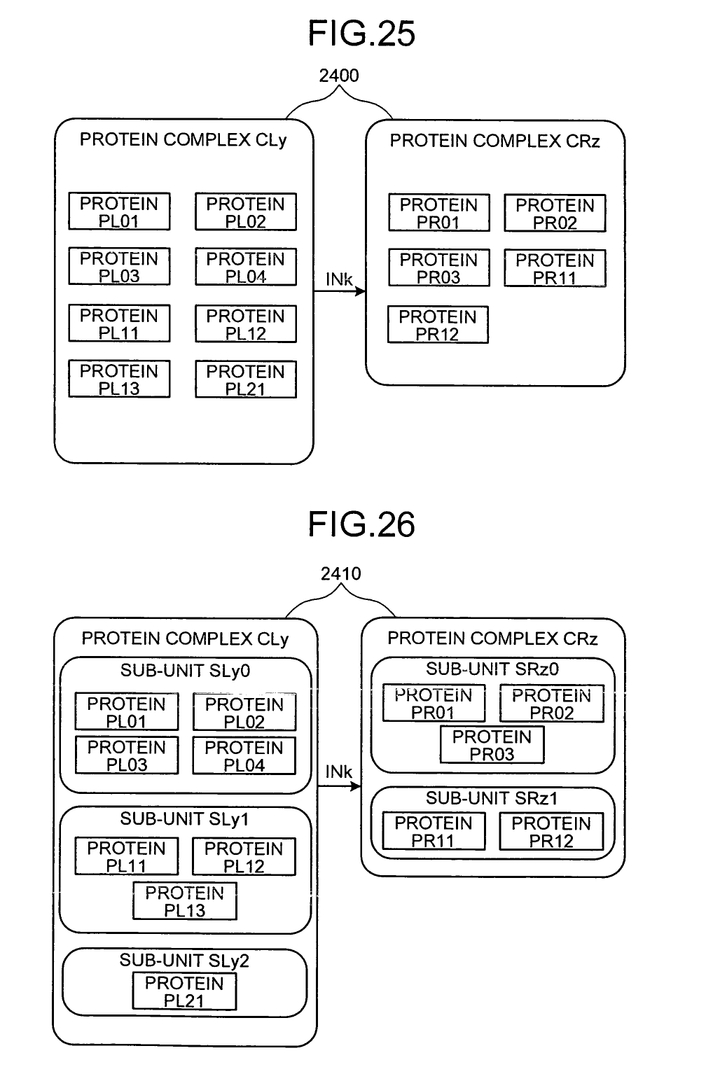

FIG. 25 is a schematic for illustrating the prediction target complex pair information 2400 supplied to the sub-unit forming unit 201. In FIG. 25, by way of example, the complex pair information 2400 represents interaction (interaction type INk) between a protein complex CLy including proteins PL01 to PL04, PL11 to PL13, PL21 and a protein complex CRz including proteins PR01 to PR03, and PR11 to PR12. If the interaction attribute is unknown, the interaction type INk is not included.

As described above, the sub-unit forming unit 201 generates sub-unit complex pair information 2410 from the prediction target complex pair information 2400. FIG. 26 is a schematic for illustrating information 2410 on a sub-unit complex pair to be the prediction target. Referring to FIG. 26, in the protein complex CLy, the proteins PL01 to PL04 constitute a sub-unit SLy0; the proteins PL11 to PL13 constitute a sub-unit SLy1; and the protein PL21 constitutes a sub-unit SLy2. Similarly, in the protein complex CRz, the proteins PR01 to PR03 constitute a sub-unit SRz0 and the proteins PR11, PR12 constitute a sub-unit SRz1.

The learning data generator 1201 uses the sub-unit complex pair information 2410 as input information and refers to the GODB 220 to generate the prediction target data 250 with the process same as that for the learning data. Therefore, the prediction target data 250 has the same data structure as the aforementioned learning data.

The executing unit 204 includes a prediction-target acquiring unit 2401, a highest-order-rule extracting unit 2402, a conformity determining unit 2403, an identifying unit 2405, and an output unit 2406. The prediction-target acquiring unit 2401 acquires the prediction target data 250.

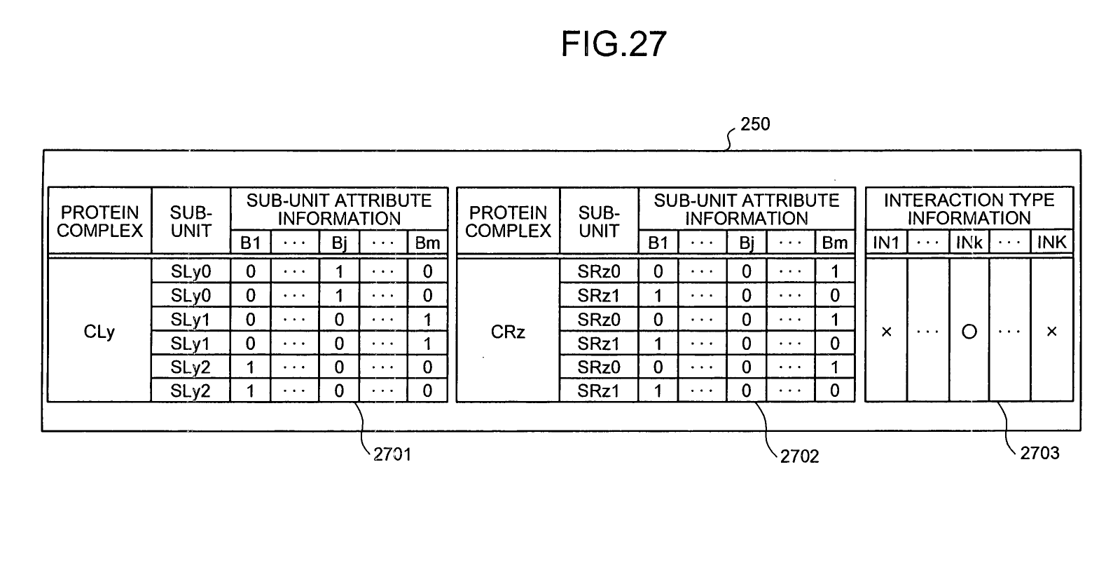

FIG. 27 is a schematic of the prediction target data 250. The prediction target data 250 includes aggregation result information 2701 of the protein complex CLy, aggregation result information 2702 of the protein complex CRz, and interaction type information 2703. If the interaction attribute is unknown, the interaction type information 2703 is not included. The prediction-target acquiring unit 2401 reads the prediction target sub-unit attribute information acquired in this way.

The highest-order-rule extracting unit 2402 shown in FIG. 24 sequentially extracts unextracted prediction rules ranked at the highest order from the prediction rule set 240 acquired by the learning unit 202. The prediction rule once extracted will not be extracted. In the initial condition, a first ranking prediction rule, i.e., a prediction rule with the highest LOD score is extracted, and the prediction rules are then extracted in the order of second ranking, third ranking, and so on.

The conformity determining unit 2403 determines whether the prediction target data 250 acquired by the prediction-target acquiring unit 2401 conforms to the prediction rule extracted by the highest-order-rule extracting unit 2402. Specifically, it is determined whether the aggregation result information of the prediction target data 250 includes the sub-unit attribute information Bj that is identical to the sub-unit attribute information Bj constituting the condition of the prediction rule. If the prediction target data 250 includes the interaction type information, it may also be determined whether the interaction type is identical.

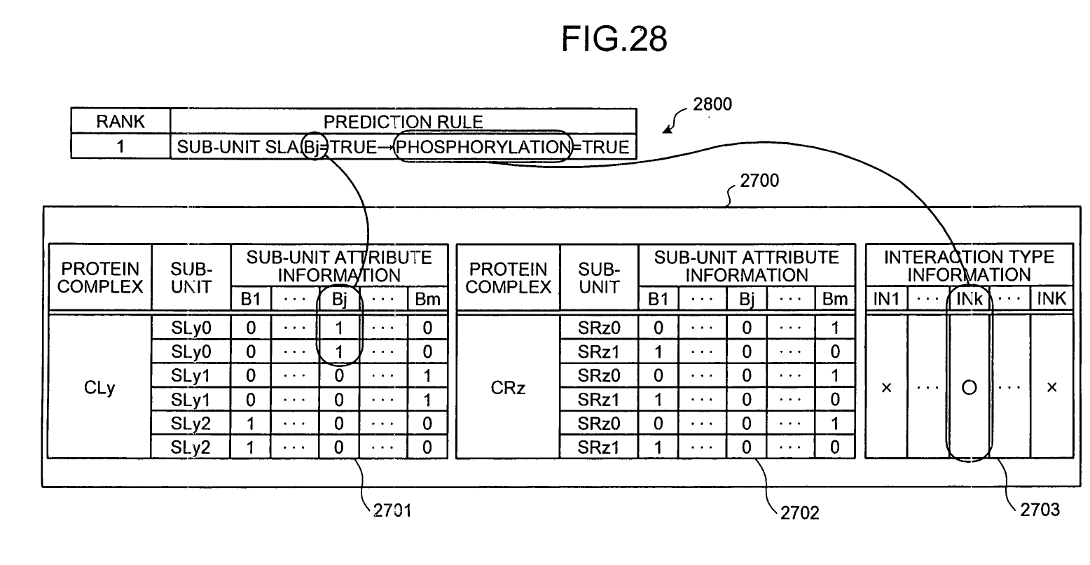

FIG. 28 is a schematic for explaining a result of the conformity determination. In the example shown in FIG. 28, the first ranking prediction rule shown in FIG. 18 is extracted. This prediction rule 2800 indicates that “in the case of the sub-unit attribute information Bj of the sub-unit SLa giving the interaction (=true), the interaction type is activation (=true)”.

On the other hand, in the aggregation result information 2701 of the protein complex CLy giving the interaction among the prediction target data 250, since the sub-unit SLy0 has the sub-unit attribute information Bj, a rule match is generated for the prediction rule 2800 between the protein complexes CLy and CRz. In this case, the both interaction types are phosphorylation (INk) and identical. Therefore, if the interaction type is considered in the conformity determination, a rule match is generated for the prediction rule 2800.

The attribute-credibility calculating unit 2404 shown in FIG. 24 calculates a prediction attribute credibility degree about the prediction rule matched with the prediction target data 250 by the conformity determining unit 2403. The prediction attribute credibility degree is an attribute score that is validation evaluation of an interaction attribute of a sub-unit pair and is calculated by using the credibility degree COjk of the prediction rule matched with the prediction target data 250. Specifically, the calculation is performed with the following Equation 4.

PCk=COr×RC (4)

In Equation 4, PCk is the prediction attribute credibility degree relating to the prediction rule generating a rule match; COr is the credibility degree COjk relating to the prediction rule generating a rule match; and RC is a remaining credibility degree. The initial value of the remaining credibility degree RC is RC=1 and the calculated prediction attribute credibility degree PCk is decremented every time the prediction attribute credibility degree PC is calculated. That is, the remaining credibility degree RC is a coefficient proportional to the order from the highest LOD score of the prediction rule after the conformity determination. Therefore, the prediction rule at the higher rank has a greater effect on the prediction attribute credibility degree PCk.

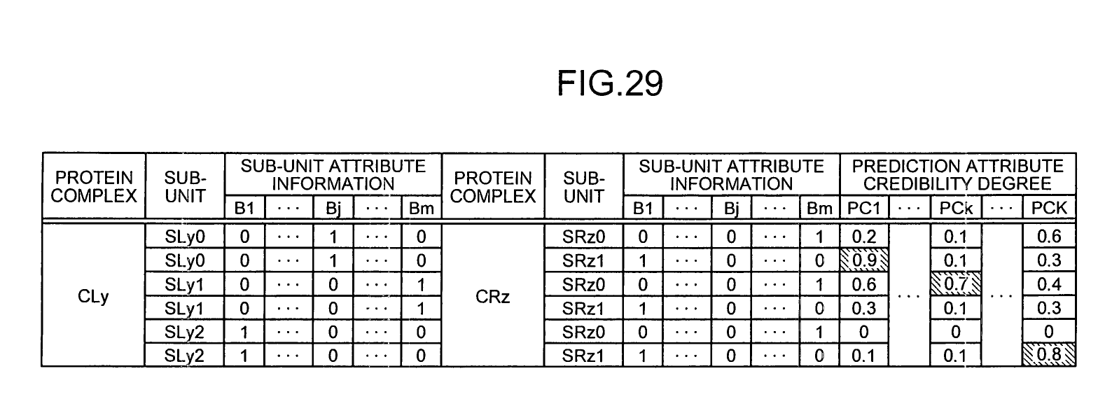

FIG. 29 is a schematic for explaining a result of calculation of the prediction attribute credibility degree PCk after applying all the prediction rules. As shown in FIG. 29, the prediction attribute credibility degree PC is calculated for each sub-unit pair SLy#, SRz# (# is a numeral).

The responsible sub-unit pair/interaction attribute identifying unit 2405 shown in FIG. 24 identifies the responsible sub-unit pair for a protein complex pair with a known interaction attribute and the interaction attribute and the responsible sub-unit pair for a protein complex pair with an unknown interaction attribute from the calculation result of the prediction attribute credibility degree PCk after applying all the prediction rules.

Specifically, for a protein complex pair with a known interaction attribute, a sub-unit pair with the highest prediction attribute credibility degree PC is identified as the responsible sub-unit pair. In the example shown in FIG. 29, if the interaction attribute is “phosphorylation” (interaction type INk), the sub-unit pair with the prediction attribute credibility degree PC=0.7 (shown with hatching in FIG. 29) is identified as the responsible sub-unit pair.

For a protein complex pair with an unknown interaction attribute, since it is not known for what interaction type INk the prediction attribute credibility degree PC should be focused on, the prediction attribute credibility degree PCk equal to or greater than a threshold value PCt is detected, and the interaction attribute is identified with the interaction type INk thereof. Since the interaction type INk is identified, the responsible sub-unit pair can be identified at the same time as is the case with the known interaction attribute.

Specifically, in the example of FIG. 29, in the case of the threshold value PCt=0.75, the prediction attribute credibility degrees PCk equal to or greater than a threshold value PCt are PC1=0.9 and PCk=0.8 (shown with hatching in FIG. 29). Therefore, because of k=1 and k=K, the interaction attribute is identified as “activation” or “inhibition”.

A sub-pair unit {SLy0, SRz1} with the prediction attribute credibility degree PC1=0.9 is identified as the responsible sub-unit pair. Similarly, a sub-pair unit {SLy2, SRz1} with the prediction attribute credibility degree PCK=0.8 is identified as the responsible sub-unit pair.

The output unit 2406 outputs an execution result, that is, the responsible sub-unit pair and the interaction attribute identified by the responsible sub-unit pair/interaction attribute identifying unit 2405. The output format may be any form such as screen display, print output, or data storage. The execution result using the sub-unit complex pair information 2410 shown in FIG. 26 will be shown.

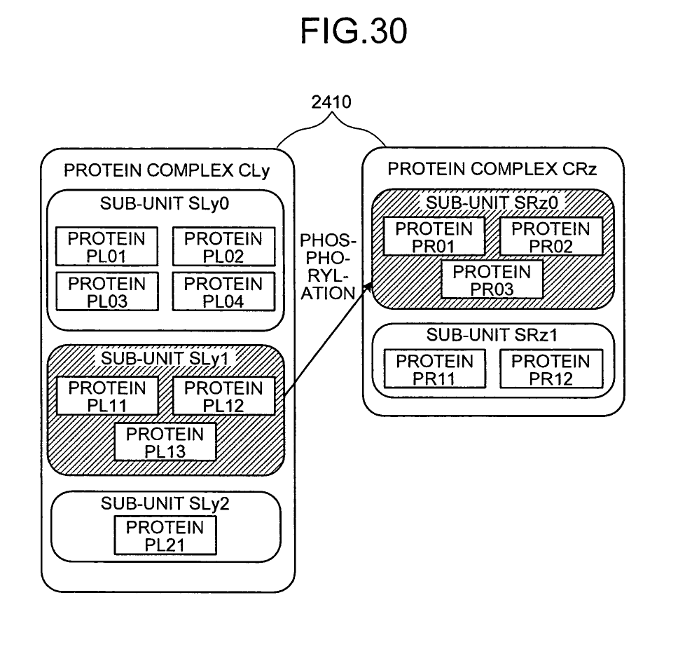

FIG. 30 is a schematic for illustrating the execution result when the interaction attribute is known (e.g., phosphorylation). The responsible sub-unit pair {SLy1, SRz0} (shown with hatching in FIG. 30) identified in the example of FIG. 29 is represented with an arrow indicating the direction of the interaction.

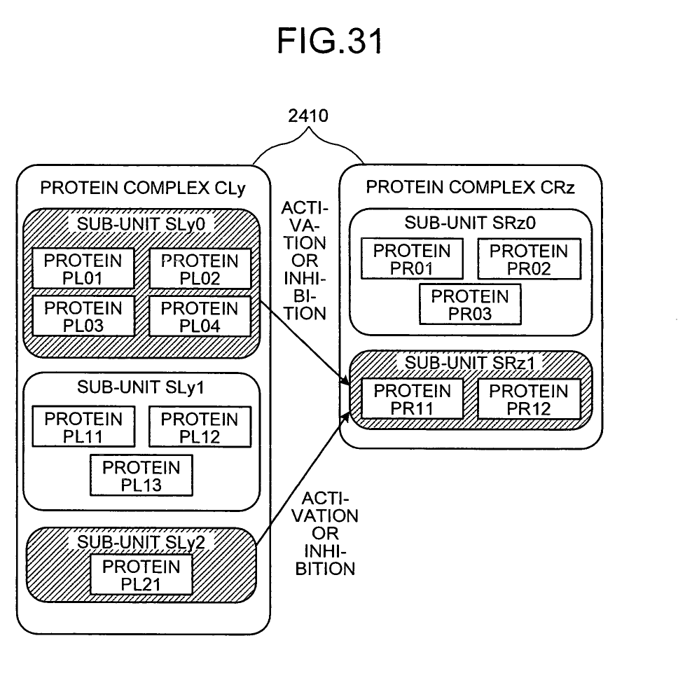

FIG. 31 is a schematic for illustrating the execution result when the interaction attribute is unknown. The responsible sub-unit pairs {SLy0, SRz1}, and {SLy2, SRz1} (shown with hatching in FIG. 31) identified in the example of FIG. 29 are represented with arrows indicating the directions of the identified interaction (inhibition, activation).

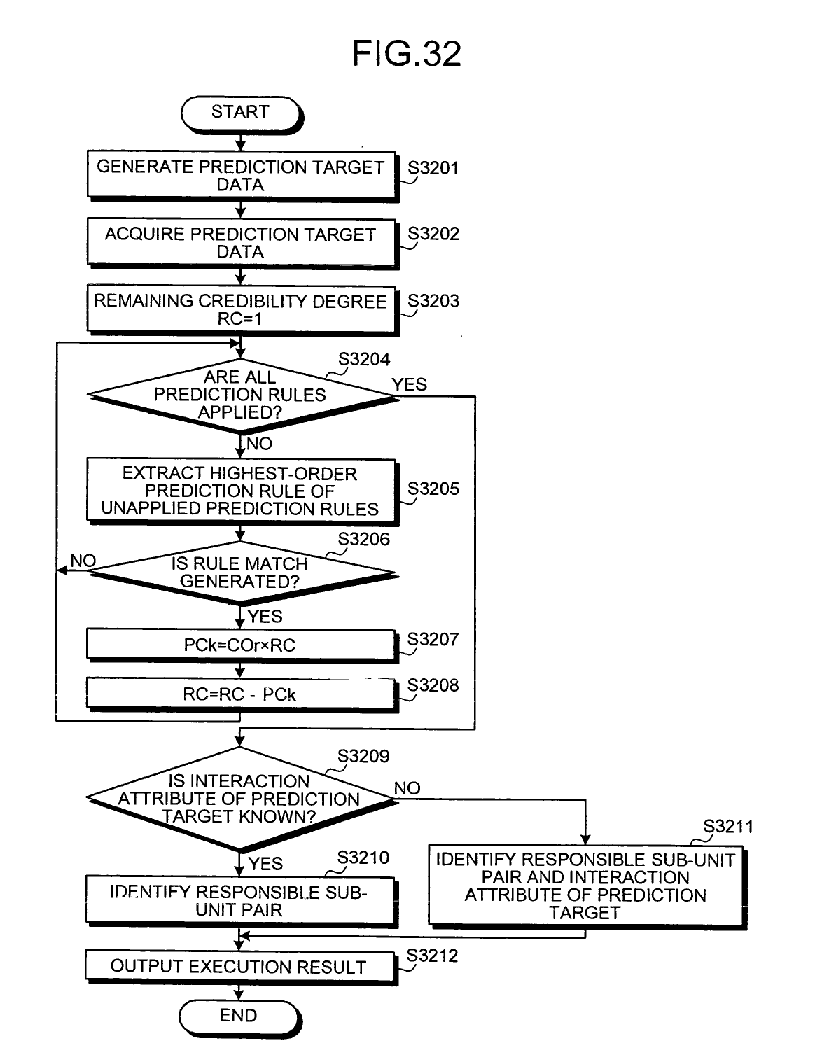

FIG. 32 is a flowchart of an execution process by the executing unit 204. The sub-unit forming unit 201 and the learning data generator 1201 generate the prediction target data 250 (step S3201).

The prediction-target acquiring unit 2401 acquires the created prediction target data 250 (step S3202). The initial value of the remaining credibility RC is set to RC=l (step S3203) and it is determined whether all the prediction rules in the prediction rule set 240 are applied to the rule match (step S3204).

If unapplied prediction rules exist (step S3204: NO), the highest-order-rule extracting unit 2402 extracts the prediction rule ranked at the highest order among the unapplied prediction rules (step S3205). The conformity determining unit 2403 determines whether a rule match is generated (step S3206).

If a rule match is not generated (step S3206: NO), the procedure goes back to step S3204. On the other hand, if a rule match is generated (step S3206: YES), the attribute-credibility calculating unit 2404 calculates the prediction attribute credibility degree PCk for the prediction rule generating the rule match (step S3207). The calculated prediction credibility degree PCk is subtracted from the current remaining credibility degree RC to update the remaining credibility degree RC (step S3208) and the procedure goes back to step S3204.

If all the prediction rules are applied at step S3204 (step S3204: YES), it is determined whether the interaction attribute of the prediction target is known (step S3209). If the interaction attribute is known (step S3209: YES), the responsible sub-unit pair/interaction attribute identifying unit 2405 identifies the responsible sub-unit pair (step S3210) that is output as the execution result (step S3212).

On the other hand, if the interaction attribute is unknown (step S3209: NO), the responsible sub-unit pair/interaction attribute identifying unit 2405 identifies the interaction attribute between prediction target protein complexes and the responsible sub-unit pair thereof (step S3211) that are output as the execution result (step S3212).

Thus, according to the prediction-target generating unit 203 and the executing unit 204 described above, the responsible sub-unit pair can be deduced for the protein complex pair with the known interaction attribute. The interaction attribute and the responsible sub-unit pair can be deduced at the same time for the protein complex pair with the unknown interaction attribute.

As described above, according to the protein complex interaction evaluating program, the recording medium recording the program, the interaction evaluating apparatus, and the protein complex interaction evaluating method, the validation evaluation of the interaction attribute can be achieved effectively and highly accurately.

The protein complex interaction evaluating method described in the embodiment can be realized by executing a program prepared in advance with a computer such as a personal computer and a workstation. The program is recorded on a computer-readable recording medium such as an HD, a FD, a CD-ROM, an MO, and a DVD and is read from the recording medium by the computer for execution. The program may be a transmission medium that can be distributed through a network such as the Internet.

According to the embodiments described above, validity evaluation can be performed for an interaction attribute effectively and highly accurately.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a computer program for evaluating interaction between protein complexes, the computer program making a computer execute:
extracting, from a group of pair information representing a protein complex pair that includes protein complexes having interaction therebetween, a sub-unit composed of proteins having similar nature among proteins forming the protein complexes;
determining whether protein attribute information of the protein included in the sub-unit is present in a group of protein attribute information identifying an attribute of protein;
creating sub-unit attribute information that identifies an attribute of the subunit for each of the protein attribute information, by aggregating information on presence or absence of protein attribute information determined at the determining;
generating learning data including information on presence or absence of the sub-unit attribute information and interaction attribute information identifying the interaction for each piece of the complex pair information so as to cover all sub-unit pairs formed by combination of sub-units in a protein complex giving the interaction and sub-units in a protein complex receiving the interaction; and
extracting a prediction rule applied to prediction-target complex-pair information representing a prediction-target protein-complex pair of which a sub-unit pair affected by the interaction is unknown or a prediction-target protein-complex pair of which interaction is unknown, from a set of rules defining the sub-unit attribute information as a condition and the interaction attribute information as a conclusion, the rules being obtained from a set of the learning data.

2. The computer-readable recording medium according to claim 1, wherein
the computer program further makes the computer execute:
detecting, from the learning data, number of sub-units having only the sub-unit attribute information and number of sub-units having both the sub-unit attribute information and the interaction attribute information; and
calculating credibility for the rule based on a result of detection at the detecting, and
the extracting a prediction rule includes extracting the prediction rule based on the credibility.

3. The computer-readable recording medium according to claim 2, wherein
the computer program further makes the computer execute calculating a support degree of the rule based on the number of the sub-units and total number of the sub-units, and
the extracting a prediction rule includes extracting the prediction rule based on the support degree.

4. The computer-readable recording medium according to claim 2, wherein the computer program further makes the computer execute calculating a log-of-odds score of the prediction rule based on the number of the sub-units.

5. The computer-readable recording medium according to claim 2, wherein the computer program further makes the computer execute:
acquiring prediction target data that is learning data of the prediction-target complex-pair information;
judging whether a rule conforming to the prediction rule exists in the prediction target data;
identifying, based on a result of judgment at the judging, at least one of a responsible sub-unit pair affected by interaction and an interaction attribute using the prediction rule; and
outputting a result of identification at the identifying, and
for the prediction-target protein-complex pair of which the interaction attribute is known, the responsible sub-unit pair is identified at the identifying, and
for the prediction-target protein-complex pair of which the interaction attribute is unknown, the responsible sub-unit pair and the interaction attribute are identified at the identifying.

6. The computer-readable recording medium according to claim 5, wherein
the identifying includes identifying at least one of the responsible sub-unit pair and the interaction attribute based on the credibility of the prediction rule that is judged to be in conformity at judging.

7. The computer-readable recording medium according to claim 6, wherein
the identifying includes identifying at least one of the responsible sub-unit pair and the interaction attribute based on a coefficient proportional to an order from highest log-of-odds score of the prediction rule.

8. The computer-readable recording medium according to claim 1, wherein
the computer program further makes the computer execute:
acquiring complex pair information representing a protein complex pair affected by interaction;
identifying, based on a family list in which families representing nature of protein are grouped, an exclusive family that is a representative family representing nature of each of the proteins from among the families in the family list; and
grouping proteins forming protein complexes in the complex pair information into sub-units each of which including proteins having a common exclusive family to convert the complex pair information into sub-unit complex pair information, and
the extracting a sub-unit includes extracting the sub-unit from the sub-unit complex pair information.

9. A computer-readable recording medium that stores therein a computer program for evaluating interaction between protein complexes, the computer program making a computer execute:
acquiring complex pair information representing a protein complex pair affected by interaction;
identifying, based on a family list in which families representing nature of protein are grouped, an exclusive family that is a representative family representing nature of each of the proteins from among the families in the family list; and
grouping proteins forming protein complexes in the complex pair information into sub-units each of which including proteins having a common exclusive family.

10. An apparatus for evaluating interaction between protein complexes, comprising:
a sub-unit extracting unit configured to extract, from a group of pair information representing a protein complex pair that includes protein complexes having interaction therebetween, a sub-unit composed of proteins having similar nature among proteins forming the protein complexes;
a determining unit configured to determine whether protein attribute information of the protein included in the sub-unit is present in a group of protein attribute information identifying an attribute of protein;
a creating unit configured to create sub-unit attribute information that identifies an attribute of the subunit for each of the protein attribute information, by aggregating information on presence or absence of protein attribute information determined by the determining unit;
a generating unit configured to generate learning data including information on presence or absence of the sub-unit attribute information and interaction attribute information identifying the interaction for each piece of the complex pair information so as to cover all sub-unit pairs formed by combination of sub-units in a protein complex giving the interaction and sub-units in a protein complex receiving the interaction; and
a prediction-rule extracting unit configured to extract a prediction rule applied to prediction-target complex-pair information representing a prediction-target protein-complex pair of which a sub-unit pair affected by the interaction is unknown or a prediction-target protein-complex pair of which interaction is unknown, from a set of rules defining the sub-unit attribute information as a condition and the interaction attribute information as a conclusion, the rules being obtained from a set of the learning data.

11. An apparatus for evaluating interaction between protein complexes comprising:
an acquiring unit configured to acquire complex pair information representing a protein complex pair affected by interaction;
an identifying unit configured to identify, based on a family list in which families representing nature of protein are grouped, an exclusive family that is a representative family representing nature of each of the proteins from among the families in the family list; and
a grouping unit configured to perform grouping on proteins forming protein complexes in the complex pair information into sub-units each of which including proteins having a common exclusive family.

12. A method of evaluating interaction between protein complexes, comprising:
extracting, from a group of pair information representing a protein complex pair that includes protein complexes having interaction therebetween, a sub-unit composed of proteins having similar nature among proteins forming the protein complexes;
determining whether protein attribute information of the protein included in the sub-unit is present in a group of protein attribute information identifying an attribute of protein;
creating sub-unit attribute information that identifies an attribute of the subunit for each of the protein attribute information, by aggregating information on presence or absence of protein attribute information determined at the determining;
generating learning data including information on presence or absence of the sub-unit attribute information and interaction attribute information identifying the interaction for each piece of the complex pair information so as to cover all sub-unit pairs formed by combination of sub-units in a protein complex giving the interaction and sub-units in a protein complex receiving the interaction; and
extracting a prediction rule applied to prediction-target complex-pair information representing a prediction-target protein-complex pair of which a sub-unit pair affected by the interaction is unknown or a prediction-target protein-complex pair of which interaction is unknown, from a set of rules defining the sub-unit attribute information as a condition and the interaction attribute information as a conclusion, the rules being obtained from a set of the learning data.

13. A method of evaluating interaction between protein complexes comprising:
acquiring complex pair information representing a protein complex pair affected by interaction;
identifying, based on a family list in which families representing nature of protein are grouped, an exclusive family that is a representative family representing nature of each of the proteins from among the families in the family list; and
grouping proteins forming protein complexes in the complex pair information into sub-units each of which including proteins having a common exclusive family.
